(19) United States
(12) Patent Application Publication
(10) Pub. No.: US 2023/0120636 A1
(43) Pub. Date: Apr. 20, 2023

(54) Item Identification and Tracking System and Data Access and Governance System

(71) Applicant: Aglive International Pty Ltd., Victoria (AU)

(72) Inventors: Mark TOOHEY, Burwood (AU); Alex TAYLOR, Burwood (AU); Jason WILLIAMS, Burwood (AU)

(21) Appl. No.: 17/895,593

(22) Filed: Aug. 25, 2022

Related U.S. Application Data
(63) Continuation-in-part of application No. 17/844,711, filed on Jun. 20, 2022.
Application No. 17/844,711 is a continuation of application No. 16/089,995, filed on Sep. 28, 2018, now Pat. No. 11,367,039.

(30) Foreign Application Priority Data
Mar. 31, 2016 (AU) 2016901208
Jan. 16, 2017 (AU) 2017900116
Aug. 19, 2022 (AU) 2022902382

(51) Int. Cl. G06Q 10/0833; G06Q 10/087; G06Q 50/28; G06Q 10/083; H04W 4/35; G06K 19/077

(52) U.S. Cl. CPC G06Q 10/0833; G06Q 10/087; G06Q 50/28; G06Q 10/083; H04W 4/35; G06K 19/07758

(57) ABSTRACT

A method of uniquely identifying an item, the item being a member of a batch of nominally identical items. Each item is characterised by variability within the batch with respect to at least one inherent characteristic of the item. The at least one inherent characteristic of the item arises from a material or process used in manufacture of the item. The method includes scanning each item at a point of manufacture with respect to the at least one inherent characteristic. Data is acquired on the at least one inherent characteristic sufficient to uniquely distinguish the item from other items of the batch.

### CROSS-REFERENCE TO RELATED APPLICATIONS AND PRIORITY

This patent application is a Continuation-in-Part of U.S. patent application Ser. No. 17/844,711 filed Jun. 20, 2022 which is a Continuation of U.S. patent application Ser. No. 16/089,995 filed Sep. 28, 2018 (U.S. Pat. No. 11,367,039 issued Jun. 21, 2022) which claims priority from PCT Application No. PCT/AU2017/000078 filed Mar. 31, 2017, which claims priority from Australian Patent Application No. 2017900116 filed Jan. 16, 2017 and Australian Patent Application No. 2016901208 filed Mar. 31, 2016. This patent application additional claims priority to Australian Patent Application No. 2022902382 filed Aug. 19, 2022. Each of these patent applications are herein incorporated by reference in their entirety.

### TECHNICAL FIELD OF THE INVENTION

This invention relates to a system and method for verification of the origin of goods or items. More particularly, but not exclusively, the invention relates to the matching of goods or items with a record maintained in respect of the lifecycle of the goods or items.

### BACKGROUND

It is important to suppliers of goods or items, on the one hand, and on the other hand to customers or distributors receiving the goods, to be confident that those goods are authentic, i.e., that what leaves the supplier is what has reached the customer or distributor. Apart from the problem of defeating counterfeiting and substitution, manufacturers wish to be able to track back to their source any goods found to be faulty, so that remedial measures can be taken.

To this end, it is normal to mark goods with a serial number, batch number, barcode or other identifying mark, with appropriate records of such markings being kept by the supplier.

However, such marks may themselves be expensive to apply and may themselves be counterfeited. What is desirable is a way to enable goods to be tracked and authenticated as genuine with little or no risk of counterfeit or other non-genuine goods being substituted for them, and with either no or very minor modification to ordinary production processes used in manufacture of the goods.

No mention or discussion of the prior art herein, is to be taken as an admission that that prior art is citable prior art or part of the common general knowledge of persons skilled in the art in any country.

### SUMMARY OF THE INVENTION

### Definitions and Usages

“Unique”: Herein, this term and derivatives thereof, as used for example in the phrase “uniquely identifying” is to be understood as including both truly unique, meaning “of which there is only one” and substantially unique, meaning (in relation to an item) “of which there is only one or at most a very small number by comparison with a relevant population of the items”.

“Scan”: Herein, this term, and derivatives thereof, as for example in “scanning device”, means a procedure (or the result of a procedure) in which a property of an item is measured or observed using appropriate sensor(s) capable of measuring or resolving the property with appropriate accuracy or precision, and may include the forming of an image showing a spatial distribution of the property.

“Inherent”: Herein, this term when used in relation to a property or characteristic of an item, means existing in the item as a permanent and inseparable element, quality or attribute. An inherent characteristic is accordingly one that will not in the absence of action to change it vary between two successive scans.

“Item”: Herein, this term may refer to a tangible good or entity, with or without associated packaging. The tangible entity may be inanimate or animate.

The term “comprising” (and grammatical variations thereof) is used in this specification in the inclusive sense of “having” or “including”, and not in the exclusive sense of “consisting only of”.

The invention provides in a first aspect a method of uniquely identifying an item, the item being a member of a batch of nominally identical items, wherein: each item is characterized by variability within the batch with respect to at least one inherent characteristic of the item.

Where the item is inanimate, the at least one inherent characteristic of the item may arise from a material or process used in manufacture of the item;

Where the item is animate, the at least one inherent characteristic of the item may arise from natural variability imparted by nature in the creation (manufacture if you will) of the being.

In a preferred form said method comprises:

scanning each item at a point of manufacture with respect to said at least one inherent characteristic thereby to acquire data on the at least one inherent characteristic sufficient to uniquely distinguish the item from other items of the batch.

The or at least one inherent characteristic may be a measurable property.

An inherent characteristic may be one of weight, transparency, or a dimension of the item.

The or at least one inherent characteristic may be a characteristic observable in an image formed by scanning of a portion of the item.

The image may be of a portion of a surface of the item.

The image may be one of a plurality of images of the item taken under different lighting conditions or from different viewpoints.

An inherent characteristic may be one of color, or distribution of color of the item.

An inherent characteristic may be a marking applied to the item in the course of manufacture.

At least first and second inherent characteristics of the item may be scanned whereby to uniquely distinguish the item from other members of the batch. It is the preferred that the first and second inherent characteristics are different inherent characteristics of the item.

In a second aspect, the invention provides a method for tracking an item, being a member of a batch of nominally identical items, comprising, for each item of the batch, the steps of:

in an initial scan acquiring data on at least one inherent characteristic of the item sufficient to uniquely distinguish the item from other items of the batch, according to the method of uniquely identifying an item in any of the forms disclosed herein;
storing the data and/or information derived therefrom sufficient to distinguish the item from other items of the batch, in digital form, on a database;
at a second location, performing a second scan comprising scanning an item received at the second location for the or each characteristic used in the initial scan;
seeking a match between data and/or information derived therefrom acquired in the second scan with corresponding data stored in the database.

Preferably, each item is allocated a unique identifier and the data from the initial scan and/or information derived therefrom for that item is stored with the unique identifier for that item.

In another broad form of the invention, there is provided a method of permitting access to data wherein access to the data is a function of an access parameter.

Preferably, the access parameter includes identity of the entity seeking access to the data.

Preferably, the access parameter includes need of the entity.

Preferably, the access parameter includes time.

Preferably, the data pertains to an item; the item identified in accordance with the method described above.

Preferably, the method is applied to the method of tracking the item described above.

In another broad form of the invention, there is provided a method for recording a custodial chain and identifying anomalies in the chain; said method comprising defining or identifying a first element and assigning a first element identifier to it;

associating the first element identifier physically with the first element;
defining or identifying at least a second element and assigning a second element identifier to it;
associating the second element identifier physically with the second element;
aggregating the at least first element and second element physically as an aggregated element and assigning an aggregated element identifier to it;
defining an aggregated element record which includes the aggregated element identifier and the at least first element identifier and the at least second element identifier;
recording the identifiers as records in a database.

Preferably, the database is located remotely from the chain or any component of the chain.

Preferably, the method further includes associating a sub element with each element identifier; the sub element containing data related to the element identifier and its passage along the chain.

Preferably, the sub-element contains customization data.

Preferably, the customization data includes a custodian identifier unique to each custodian in the chain.

Preferably, the method further comprises multiple, successive aggregation steps, followed by multiple de-aggregation steps.

Preferably, the method further comprises multiple, successive aggregation steps, defining multiple successive aggregation records, followed by multiple de-aggregation steps, made with reference to the aggregation records.

Preferably, the database is in the form of a blockchain structure.

Preferably, the steps in the chain include spending, allocating, transacting.

Preferably, the method further includes the step of reading and communicating the identifiers to the database each time an event occurs in the custodial chain.

Preferably, the method further includes the step of amending the sub element at the time of each event.

Preferably, the step of amending occurs during a step of spending.

Preferably, a checking step involves checking that each identifier is identified only once at each step/event in the chain.

Preferably, the method further includes the step of raising an alarm condition if identifier is identified more than once or if an identifier does not exist in the database.

Preferably, an alarm condition is excluded if the sub element data is changed as part of an event.

Preferably, the sub element includes the address of a holder.

Preferably, the sub element includes rules created by the Originator.

In another broad form of the invention, there is provided a method of verification of an aspect of an item; said method comprising of ascribing a unique identifier to the item in respect of that aspect; storing the unique identifier in a table referenced against the item on a server; causing transmission of the item from a first location to a second location; a user accessing by reference to the item itself the unique identifier ascribed to the item; causing a comparison of the unique identifier thus obtained with the unique identifier stored on the server referenced against the item whereby the aspect of the item is verified if the unique identifier thus obtained matches with the unique identifier stored on the server referenced against the item.

Preferably, the aspect comprises the origin of the item.

Preferably, the aspect comprises the sponsorship or approval of the item.

Preferably, the aspect comprises the originator of the item.

Preferably, the table is maintained in a blockchain structure maintained by and accessible across a multiplicity of servers.

In another broad form of the invention, there is provided a computer program comprising of at least one instruction for controlling a computer system for to implement a method as described above.

In another broad form of the invention, there is provided a computer readable medium storing a computer program as described above.

In another broad form of the invention, there is provided a communications signal transmitted by an electronic system implementing a method as described above.

In another broad form of the invention, there is provided a system of verification of an aspect of an item; said system comprising a processor which ascribes a unique identifier to the item in respect of that aspect; the processor storing the unique identifier in a table in memory referenced against the item on a server; causing transmission of the item from a first location to a second location by use of a communications system; a user accessing by use of a digital device and by reference to the item itself the unique identifier ascribed to the item; the digital device and the processor causing a comparison of the unique identifier thus obtained with the unique identifier stored on the server referenced against the item whereby the aspect of the item is verified if the unique identifier thus obtained matches with the unique identifier stored on the server referenced against the item.

Preferably, the aspect comprises the origin of the item.

Preferably, the aspect comprises the sponsorship or approval of the item.

Preferably, the aspect comprises the origin of the item.

Preferably, the aspect comprises the sponsorship or approval of the item.

Preferably, the aspect comprises the originator of the item.

Preferably, the table is maintained in a blockchain structure maintained by and accessible across a multiplicity of servers.

Preferably, the table is maintained in a blockchain structure maintained by and accessible across a multiplicity of servers.

In another broad form of the invention, there is provided a Media containing code which, when executed by a processor, implements the method as described above.

In another broad form of the invention, there is provided a handheld digital communications device incorporating at least a processor, a memory, radio communications apparatus and input output apparatus having code is stored in the memory which when executed by the processor causes the device to acquire at least one aspect of an item of the system described above.

Preferably, the device further includes GPS apparatus in communication with the memory and processor whereby information as to location of the device in three-dimensional space is acquired for use and on transmission by the device.

Preferably, the device further includes geolocation apparatus in communication with the memory and processor whereby information as to location of the device in three-dimensional space is acquired for use and on transmission by the device.

The method, system or device as described above wherein the data pertains to an item; the item identified in accordance with the method described above.

The method described above applied to the method of tracking the item described above.

In another broad form of the invention, there is provided a method of permitting access to data wherein access to the data is a function of an access parameter; the data comprising an element identifier of the method described above.

Preferably, the access parameter includes identity of the entity seeking access to the data.

Preferably, the access parameter includes need 107 of the entity.

Preferably, the access parameter includes time.

Preferably, the data pertains to an item; the item identified in accordance with the method described above.

The method described above applied to the method of tracking the item described above.

In another broad form of the invention, there is provided a system of permitting access to data wherein access to the data is a function of an access parameter; the data comprising an element identifier of the method described above.

Preferably, the access parameter includes identity of the entity seeking access to the data.

Preferably, the access parameter includes need of the entity.

Preferably, the access parameter includes time.

The system described above wherein the data pertains to an item; the item identified in accordance with the method described above.

Preferably, the system is applied to the method of tracking the item as described above.

In a further broad form of the invention there is provided a method for recording a custodial chain and identifying anomalies in the chain in combination with the method described above; said method comprising defining or identifying a first element and assigning a first element identifier to it; associating the first element identifier physically with the first element; defining or identifying at least a second element and assigning a second element identifier to it; associating the second element identifier physically with the second element; aggregating the at least first element and second element physically as an aggregated element and assigning an aggregated element identifier to it; defining an aggregated element record which includes the aggregated element identifier and the at least first element identifier and the at least second element identifier; recording the identifiers as records in a database.

In a further broad form of the invention there is provided a method for recording a custodial chain and identifying anomalies in the chain in combination with the system described above; said method comprising

defining or identifying a first element and assigning a first element identifier to it;
associating the first element identifier physically with the first element;
defining or identifying at least a second element and assigning a second element identifier to it;
associating the second element identifier physically with the second element;
aggregating the at least first element and second element physically as an aggregated element and assigning an aggregated element identifier to it;
defining an aggregated element record which includes the aggregated element identifier and the at least first element identifier and the at least second element identifier;
recording the identifiers as records in a database.

Preferably the method further includes associating a sub element with each element identifier; the sub element containing data related to the element identifier and its passage along the chain.

Preferably the database is in the form of a blockchain structure.

Preferably the database is in the form of a distributed database structure.

Preferably the sub-element contains customization data.

Preferably the customization data includes a custodian identifier unique to each custodian in the chain.

Preferably the method comprises multiple, successive aggregation steps, followed by multiple de-aggregation steps.

Preferably the method comprises multiple, successive aggregation steps, defining multiple successive aggregation records, followed by multiple de-aggregation steps, made with reference to the aggregation records.

Preferably the steps in the chain include spending, allocating, transacting.

Preferably the method further includes the step of reading and communicating the identifiers to the database each time an event occurs in the custodial chain.

Preferably the method further includes the step of amending the sub element at the time of each event.

Preferably the method further includes the step of amending which occurs during a step of spending.

Preferably the method further includes a checking step which involves checking that each identifier is identified only once at each step/event in the chain.

Preferably the method further includes the step of raising an alarm condition if identifier is identified more than once or if an identifier does not exist in the database.

In a preferred form an alarm condition is excluded if the sub element data is changed as part of an event.

In a preferred form the sub element includes the address of a holder.

In a preferred form the sub element includes rules created by the originator.

Preferably the sub element includes rules created by the originator.

In a further broad form of the invention there is provided a method of verification of an aspect of an item in combination with any one of the methods described above; said method comprising of ascribing a unique identifier to the item in respect of that aspect; storing the unique identifier in a table referenced against the item on a server; causing transmission of the item from a first location to a second location; a user accessing by reference to the item itself the unique identifier ascribed to the item; causing a comparison of the unique identifier thus obtained with the unique identifier stored on the server referenced against the item whereby the aspect of the item is verified if the unique identifier thus obtained matches with the unique identifier stored on the server referenced against the item.

Preferably the aspect comprises the origin of the item.

Preferably the aspect comprises the sponsorship or approval of the item.

Preferably the aspect comprises the originator of the item.

Preferably the table is maintained in a blockchain structure maintained by and accessible across a multiplicity of servers.

In yet a further broad form of the invention there is provided a computer program comprising of at least one instruction for controlling a computer system for to implement the method or the combination of methods described above.

In a further broad form, there is provided a computer readable medium storing instruction for a computer program which implements the method or the combination of methods described above.

In yet a further broad form there is provided a communications signal transmitted by an electronic system implementing the method or combination of methods as described above.

In yet a further broad form of the invention there is provided a system of verification of an aspect of an item in combination with the system described above; said system comprising a processor which ascribes a unique identifier to the item in respect of that aspect; the processor storing the unique identifier in a table in memory referenced against the item on a server; causing transmission of the item from a first location to a second location by use of a communications system; a user accessing by use of a digital device and by reference to the item itself the unique identifier ascribed to the item; the digital device and the processor causing a comparison of the unique identifier thus obtained with the unique identifier stored on the server referenced against the item whereby the aspect of the item is verified if the unique identifier thus obtained matches with the unique identifier stored on the server referenced against the item.

Preferably the aspect comprises the origin of the item.

Preferably the aspect comprises the sponsorship or approval of the item.

Preferably the aspect comprises the origin of the item.

Preferably the aspect comprises the sponsorship or approval of the item.

Preferably the aspect comprises the originator of the item.

Preferably the table is maintained in a blockchain structure maintained by and accessible across a multiplicity of servers.

Preferably the table is maintained in a blockchain structure maintained by and accessible across a multiplicity of servers.

### BRIEF DESCRIPTION OF THE DRAWINGS

FIG. 1A is a block diagram of interaction of database feeds with a register of NFTs on a blockchain in accordance with a first embodiment of the invention.

FIG. 1B is a more detailed block diagram of data exchange between components of FIG. 1A.

FIG. 1C and FIG. 1D are schematic diagrams showing in FIG. 1C the steps of a process for ensuring that when an item received or manufactured is dispatched by one entity, it is identifiable, and in FIG. 1D the steps of a process for identifying/authenticating the item as genuine when it is received by another entity.

FIG. 2 is a schematic diagram showing items being scanned and the results stored, for identification purposes, according to the invention.

FIG. 3 shows a printed numeral and a portion thereof as printed with ink on a porous surface according to an embodiment of the invention.

FIG. 4 shows a casting that is to be identifiable being cleaned up with an angle grinder according to an embodiment of the invention.

FIG. 5 is a schematic diagram showing a process for 3D printing of a component that is to be identifiable, according to an embodiment of the invention.

FIG. 6 is a schematic diagram showing a 3D printed article being scanned by an imaging device for a pattern of internal cavities according to an embodiment of the invention.

FIG. 7 is a schematic diagram showing an injection moulding machine for plastics materials in use, and an item produced by the injection moulding machine being scanned for embedded particles according to an embodiment of the invention.

FIG. 8 is a schematic diagram showing items being marked for identification according to an embodiment of the invention.

FIG. 9 is a block schematic diagram of a data access parameter system according to a further embodiment of the invention.

FIG. 10 is a block schematic diagram of a blockchain data structure suitable for use with the data access parameter system of FIG. 9.

FIG. 11 is a logic flow diagram of a blockchain implementation of a system of FIG. 9.

FIG. 12 is a schematic diagram of the system of FIG. 9 applied in a logistics context.

FIG. 13A and FIG. 13B are schematic diagrams of the steps in the process of aggregating packages and wherein the aggregated packages are themselves subject to a three-dimensional matrix identification methodology.

FIG. 14 illustrates in block diagram form packing steps applicable in conjunction with embodiments described with reference to FIGS. 1A to 13B.

FIG. 15 illustrates an end-to-end process applicable in conjunction with embodiments described with reference to FIGS. 1A to 13B from packing steps through transfer steps to unpacking steps.

FIG. 16 illustrates in detail the application of element identifiers and sub elements during packing steps of the process of FIG. 15.

FIG. 17 illustrates an example of an unpacking and verification process.

FIG. 18 illustrates a scanning step utilizing a digital device.

FIG. 19 illustrates a package condition process.

FIG. 20 illustrates a location reporting process.

FIG. 21 illustrates an identification of an anomaly in the form of an unauthorized item process.

FIG. 22 illustrates a further example of the system applied at the granular level to control of individual items.

FIG. 23 illustrates a further embodiment of the system applied at the granular level and incorporating a timeout facility.

FIG. 24 illustrates a further exemplary embodiment of the system of the present invention.

FIG. 25 illustrates yet a further exemplary embodiment of the system of the present invention applied in the context of selective data retention and selective data availability.

FIG. 26 is a diagram of an exemplary block chain data structure.

FIG. 27 illustrates diagrammatically use of the block chain data structure of FIG. 26.

### DESCRIPTION OF EMBODIMENTS

### Unambiguous Identification and Tracking

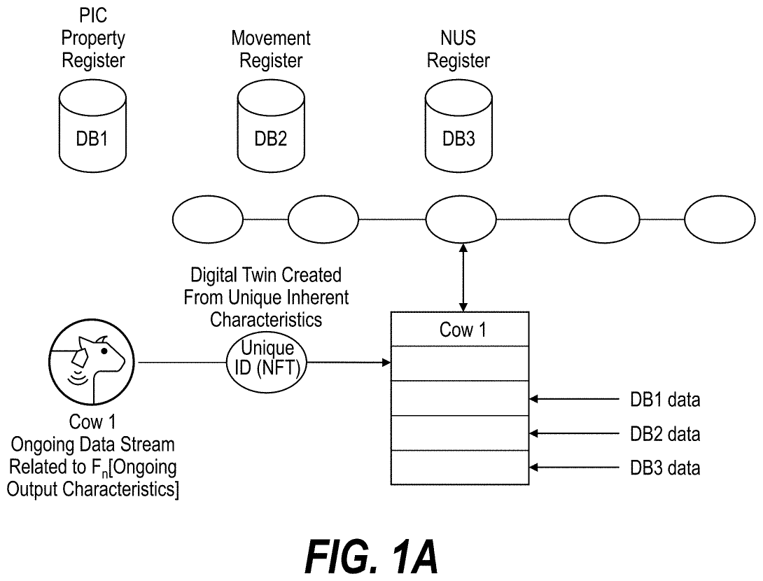

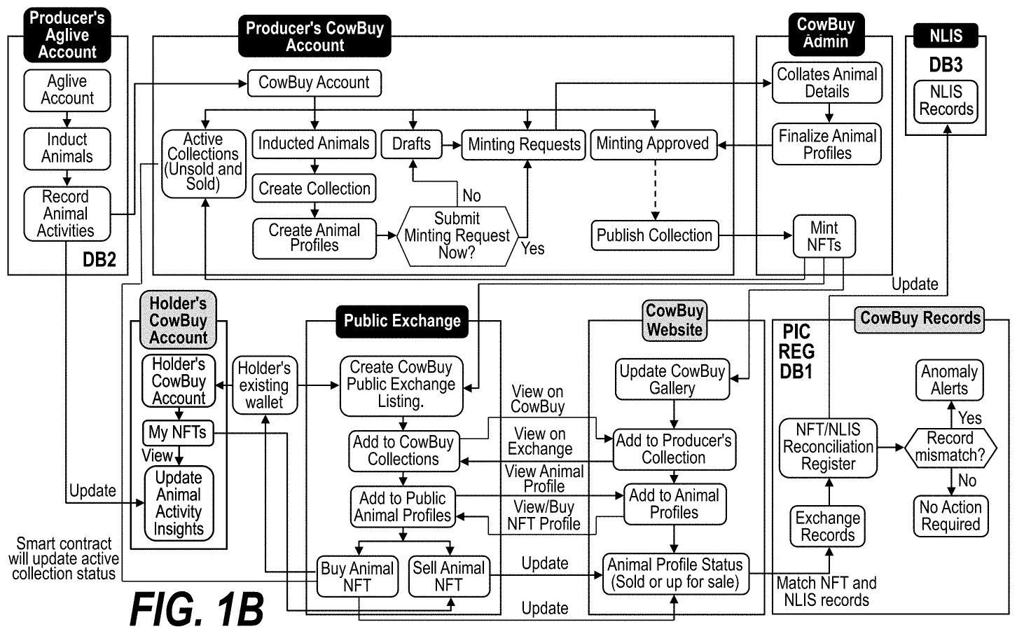

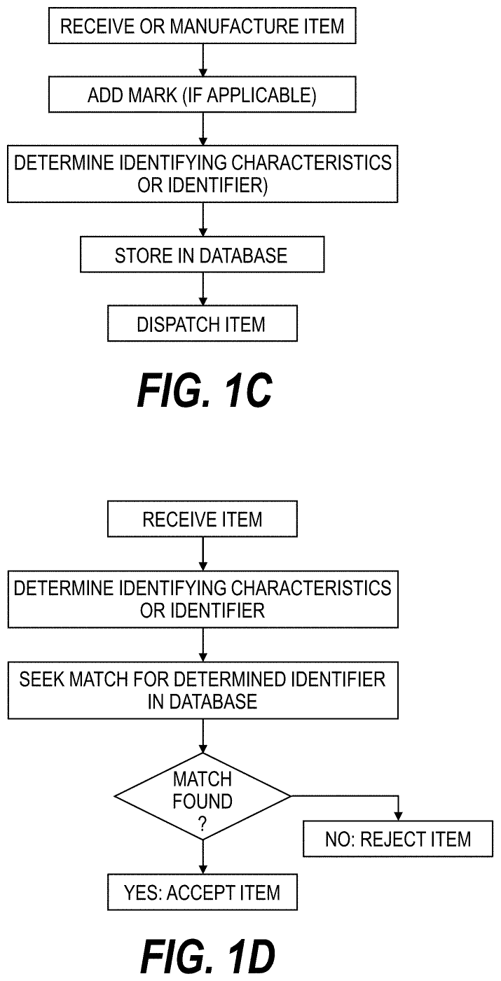

FIG. 1A is a block diagram of interaction of database feeds with a register of tokens, in this instance in the form of NFTs on a blockchain in accordance with a first embodiment of the invention;

FIG. 1B is a more detailed block diagram of data exchange between components of FIG. 1A.

With reference to FIGS. 1A and 1B, there is illustrated a system and methodology for uniquely identifying an item by utilisation of inherent characteristics of the item in a particular preferred form the methodology of uniquely identifying the item results in production of a digital token unique to the inherent characteristics of the item. In one form the digital token functions as a “digital twin” of the item.

In a particular form the digital token may be stored as a non-fungible token (NFT).

In a particular form the digital token may be stored as a non-fungible token (NFT) in a blockchain structure.

In particular forms the methodology is embodied within a system which monitors aspects of the item subsequent to creation of the digital token of the item.

In particular forms the item may be an animate item.

In more particular forms the animate item may be an item of livestock.

In more particular forms the animate item may be an item of livestock—for example, a cow.

In order to monitor aspects of the item the system may include data acquisition components.

In one form the data acquisition components may be sensors.

In particular forms the sensors may comprise image sensors.

In particular forms, the sensors may comprise milk production sensors.

In further particular forms, the data derived from the data acquisition components may be utilised to authenticate on an ongoing basis the identity of the item.

For example, data pertaining to the respiration of a cow and its milk production on a daily basis will, over time, become characteristic of that cow.

That is, no other cow will exhibit, from a statistical point of view, the same data to a relatively high level of certainty.

Stated more broadly, what is described is:

a method of uniquely identifying an item, the item being a member of a batch of nominally identical items, wherein:

each item is characterised by variability within the batch with respect to at least one inherent characteristic of the item; and

the at least one inherent characteristic of the item arises from creation of the item;

said method comprising:

scanning each item with respect to said at least one inherent characteristic thereby to acquire data on the at least one inherent characteristic sufficient to uniquely distinguish the item from other items of the batch;

creating a digital token being a function of said at least one inherent characteristic.

Preferably the at least one inherent characteristic is a measurable property.

Preferably the measurable property is a genetic code of the item.

Preferably the measurable property is a facial characteristic of the item.

Preferably the measurable property is the hide pattern of the item.

Preferably the inherent characteristic includes data pertaining to physical characteristics of the item.

Preferably the data is time-based data.

Preferably the method further includes a step of sensing attributes of the item subsequent to said step of creating said digital token.

Preferably the attributes are sensed periodically and are transmitted to a database as periodically sensed data.

Preferably the database also includes said digital token and the periodically sensed data is associated with said digital token in said database.

Preferably the or at least one inherent characteristic is a characteristic observable in an image formed by scanning of a portion of the item.

Preferably the image is of a portion of a surface of the item.

Preferably the image is one of a plurality of images of the item taken under different lighting conditions or from different viewpoints.

Preferably the inherent characteristic is one of weight, transparency, or a dimension of the item.

Preferably the inherent characteristic is one of colour, or distribution of colour of the item.

Preferably the inherent characteristic is a marking applied to the item in the course of manufacture.

Preferably the or at least the first and second inherent characteristics of the item are scanned whereby to uniquely distinguish the item from other members of the batch.

Preferably the first and second inherent characteristics are different inherent characteristics of the item.

Preferably tracking an item, being a member of a batch of nominally identical items, comprising, for each item of the batch, the steps of:

in an initial scan acquiring data on at least one inherent characteristic of the item sufficient to uniquely distinguish the item from other items of the batch;

storing the data and/or information derived therefrom sufficient to distinguish the item from other items of the batch, in digital form, on a database;

at a second location, performing a second scan comprising scanning an item received at the second location for the or each characteristic used in the initial scan;

seeking a match between data and/or information derived therefrom acquired in the second scan with corresponding data stored in the database.

Preferably at least one inherent characteristic is a measurable property.

Preferably the measurable property is a genetic code of the item.

Preferably the measurable property is a facial characteristic of the item.

Preferably the measurable property is the hide pattern of the item.

Preferably the inherent characteristic includes data pertaining to physical characteristics of the item.

Preferably the data is time-based data.

Preferably further including a step of sensing attributes of the item subsequent to said step of creating said digital token.

Preferably the attributes are sensed periodically and are transmitted to a database as periodically sensed data.

Preferably the database also includes said digital token and the periodically sensed data is associated with said digital token in said database.

Described below is more detail in relation to a methodology for identifying an item by reference to its inherent characteristics.

Embodiments disclosed herein provide a method whereby a supplier of goods can create or determine a unique identifier for an item of goods and whereby an entity receiving the item of goods can obtain a determination as to whether the item is genuine. The entity receiving the item may be an ultimate customer or an intermediary, for example a wholesaler or transport organization. The method is based on the supplier acquiring data for one or more inherent characteristics sufficient to identify a dispatched item uniquely. That data, and/or information derived from it, is stored in a database. Optionally, the item may be allocated a truly unique identifier such as a serial number. Other data relevant to the item (for example date of manufacture, intended destination or the like) may be stored as well as the data, derived information or allocated identifier, and be associable therewith.

Identification of the item and verification of its genuineness (i.e., origin with the supplier) is affected by scanning the item for the same inherent characteristics used by the manufacturer to identify the item uniquely. The data or derived information stored is distinct from any allocated identifier, serial number, batch number, barcode, trade mark or other marking placed on the item and is either impossible or difficult to counterfeit.

Referring to FIG. 1C, one or more inherent characteristics of the item are scanned, the results or information derived from the results being stored in the database. The allocation of a truly unique identifier is not shown in FIG. 1C but may be included as a further step in the process shown in FIG. 1C.

Subsequently, and as shown in FIG. 1D, an entity receiving the item may scan it, to determine the data that, if the item is genuinely from the manufacturer, should match an entry in the database. Then the supplier, or other entity granted access to the database, can seek a match for the measured data in an entry in the database. If a match is found, the item may be taken as genuine.

The nature and number of the inherent characteristics to be used for identification of an item depends on the degree of variability of each of those properties related to what the items could be and from the process of manufacture, and the accuracy and precision with which the properties may be measured. The method is applicable to batches of items, but a batch, as the term is used herein, in practice may be large, or for practical purposes infinite, for example the whole production run of a manufactured item of a particular type.

When a quantity inherent to a manufactured item (for example) is measured, values in a certain range may be obtained, and as practical measurement techniques are characterized as accurate only to a certain resolution or precision, it follows that measurement of a particular quantity can yield only a finite number of different results, hence identifiers. However, if two unrelated quantities of an item are measured and identification of the item is based on both of them, the number of possible unique identifiers is greater, being the product of the possible number of results for the two characteristics. For example, if measurement of a first quantity can provide any of 1000 different results, and measurement of a second unrelated quantity can produce any of 2000 individual results, the number of possible unique identifiers becomes 1000×2000=2,000,000. If each of the possible outcomes of the two measurements is equally likely, the probability of a false match between the results for an item and a stored pair of outcomes from a genuine article is 1 in 2,000,000. Where measurement outcomes have a statistical distribution that is other than uniform (i.e., every possible outcome equally likely), for example a normal distribution, the probability of a false match can be estimated accordingly.

The number and nature of characteristics to be relied on and the resolution of their measurement can be adjusted to suit the application. Note that where the result of scanning is an image (see examples below) the number of distinct possible outcomes may be very large or practically infinite, so that combinations of the inherent characteristics are less important.

Inherent characteristics may include characteristics that are expressible in simple numerical terms, for example weight or mass, volume, a specified dimension, genetic code, color under lighting conditions of known wavelength distribution, a resonant frequency of vibration, the gain of a transistor, resistivity, capacitance, concentration of a particular chemical consistent, or the like. Unique identifiers based on measurement of properties such as these, may comprise simply the measured value (for a single property), values themselves (i.e., not a single quantity) where several properties are relied on, or a combination, such as for example a concatenation of measured values, each expressed to a particular level of precision. Examples 6 and 7 below relate to inherent characteristics that are expressible simply as numerics.

Other inherent characteristics (as the term is used herein) may include the contents of an image of specified type, of the whole or a specified portion, of a product. Such an image may be stored in digital form. Many methods and algorithms are available, and much software is available commercially, for comparison of images as required in assessing the genuineness of an item that has been scanned to produce images. Images may also be analyzed and converted to a different form, for example a Fourier or other suitable transform, and stored in such forms for use in comparisons.

A characteristic of an item must be inherent to the item inasmuch as it will be present when the unique identification data is first acquired (at the point of supply) and present later when the data is measured by a receiver of the item. Inherency may arise inevitably as a result of the item being manufactured—for example a tangible item will have weight. However, not precluded here is the possibility that the property is given intentionally to the item, for example by the application to it of some form of marking.

### Example 1: Microscopic Features of Surfaces of Items

Surfaces of manufactured items, when examined at sufficiently high levels of magnification, exhibit microstructures that are inherent, and can be used to uniquely identify the items. This applies for example, to plastics, metals, paper, timber and the like. Moreover, the microstructures can be affected by manufacturing processes. As an example, a metal surface that has been machined may have a quite different microstructure to a surface of the same metal in a casting. Therefore, if a specific area of a surface of an item is imaged and the image stored, that image will for practical purposes be unique to the item bearing that surface, and so can identify the item uniquely, if examined closely enough, without the need to rely on applied markings such as barcodes, serial numbers or the like.

A practical method for verifying the authenticity of a manufactured item in the hands of a person receiving it, therefore can involve a manufacturer imaging a specific part of a surface portion of the item at a resolution high enough to distinguish microstructures of the surface, and storing the image. The manufacturer may assign a unique designator (such as a serial number) to the image without actually marking the item with the designator. Then, a person receiving the item can verify that it is authentic by imaging the same specific area, in the same way as the manufacturer, and comparing the image with those images stored by the manufacturer, to see if a matching image can be found in the record of the manufacturer. If such an image can be found, the item can be taken to be authentic.

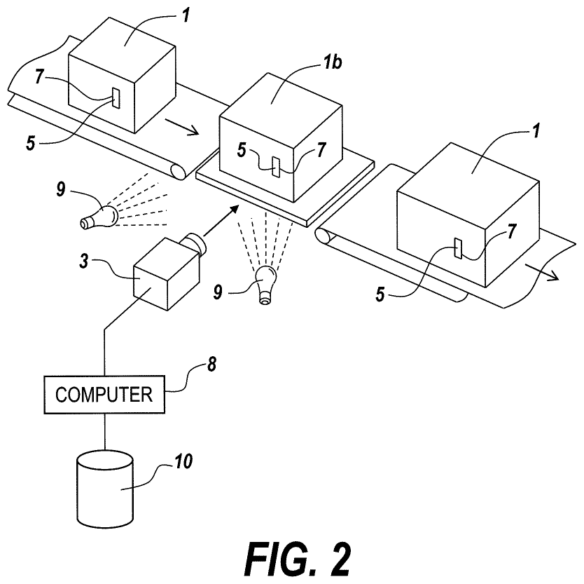

FIG. 2 shows items 1 being passed successively before a scanning device 3 in the course of production. The scanning device 3, which may for example be a digital camera, is operated to take an image of at least a portion 5 of each item (1b in FIG. 2) passing through its field of view. The imaged portion 5 of each item 1 may be designated by a marker 7 or may simply be a particular surface of item 1. Lights 9 are provided to illuminate item 1 as it is imaged. Although only one imaging device 3 is shown, there may be several (or the one device 3 may be moved) so that multiple images can be taken of each item 1 from different viewpoints, or with different light conditions.

Images (and/or data derived therefrom, taken by device 3) are stored digitally by a computer 8 in a database 10 after suitable signal processing for future reference. A designation number, code or the like may be assigned to each item 1 processed, as also may any other required data, for example batch number, date of manufacture, or the like.

Imaging at resolutions of the order required for image comparison as discussed here requires that the item be held still and in a precisely specified position by suitable means, for example clamped against a fixed plate (not shown).

In an alternative form the imaging system can be made to follow any movement of the item thereby obviating the need for the item to be held still.

Another alternative method would be to capture the (location or feature) interrelationship between a vast number of data points. In that way, if sufficient data points were mapped, motion may not hinder the scan. In fact, movement may only enhance the number of captured data points.

Similarly, the interplay between the data points while they are subject to movement may, in itself, enhance data point mapping.

As discussed below, reliance may be placed on the images only, or one or more measurable quantities may be determined, stored and used additionally. Use of such other quantities in their own right is discussed below. Further, it is possible to store only parts of images—for example, it may be found adequate in some cases to store only every 4th pixel only and still obtain reliable authentication. Metrics such as autocorrelations may be stored as well as or instead of images, and Fourier (or other suitable) transforms of images may be stored as well as or instead of the images themselves, all for use in authentication of scanned items.

There are numerous methods and algorithms known in the image matching and signal processing arts, and software is available, for comparing one image with another, to the point where the existence or non-existence of a match can be determined with a high degree of confidence.

### Example 2: Items Marked During or Following Manufacture

The method described above relies on inherent differences between items that are present due to the materials and/or the processes involved in their manufacture. However, inherent differences between items can be introduced deliberately or for reasons other than identification/authentication.

For example, markings added to at least some surfaces can, at sufficient magnification, reflect the influence of those microstructures and provide additional ways to uniquely identify the item bearing the surface. Many manufactured items require markings such as printed text, for reasons other than identification/authentication.

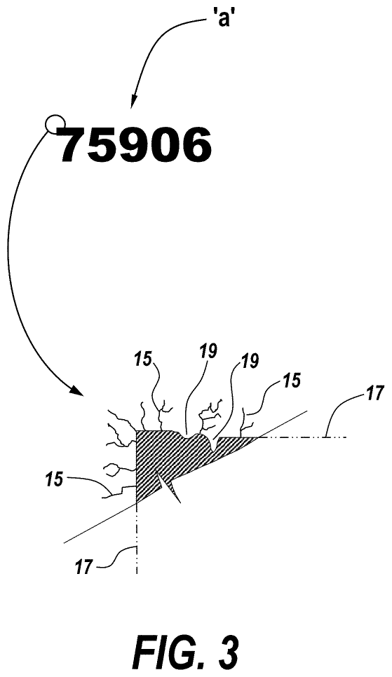

Thus, when lettering, a numeral, a barcode, or other mark is printed on paper, cardboard packaging or some other porous material using some form of ink, the edges of the inked areas are not in general sharp when seen at high magnifications. Ink in practice tends to leak beyond the nominal boundary within which it is applied due to capillary action causing an actual boundary that is different from the nominal boundary, being for example jagged. Further, the microstructures of the surface may themselves affect the actual—as opposed to nominal—boundary of inking. Hence, an image of a surface portion that includes printing can show detail that is additional to the surface microstructures themselves, whether the surface is porous or not. FIG. 3 is a sketch showing these effects, where a number “a” has been printed with ink on paper or other somewhat porous or rough surface. When examined at high resolution (for example at hundreds or thousands or pixels per cm) a nominally sharp edge of the inked area in general shows small imperfections. At some locations, inked areas 15 are shown where ink has flowed beyond the nominal boundary 17 and at other locations, deviations 19 from nominal boundary 17 are shown where ink has not extended to the nominal boundary 17. Even where laser printing is used and toner instead of liquid ink, similar effects can be seen.

Accordingly, an image of a surface portion of an item that bears printed matter, made at a sufficiently high resolution, can be used as a unique identifier of an item, in the same way as an image of the surface without printing. The imaging arrangement shown in FIG. 2 can be applied to this source of inherent item-to-item difference. Moreover, the marking itself, such as number “a” of FIG. 3, can function in the same way as markings 7 in FIG. 2, to determine where a comparison between images of ostensibly the same item 1 is to be made.

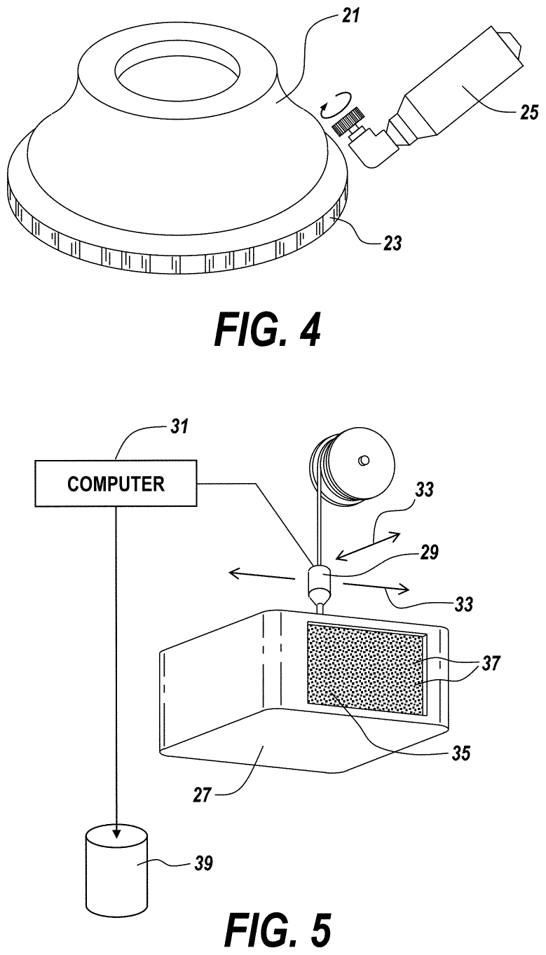

A further example of an item that is marked during manufacture, and in such a way as is likely to produce uniqueness, is an item whose production includes some degree of manual work. Humans do not repeat actions with perfect precision. In the example shown in FIG. 4, a newly-cast component 21 is “cleaned up” around an edge 23 (which may be between mould halves, not shown) using a manually operated grinder 25, leaving small markings additional to inherent microstructures in the surface due to the material being cast or to sand particles in the mould. A designated portion of edge 23 may be imaged in essentially the same way as shown in FIG. 2. Even welding, where done manually, may provide a surface that is sufficiently unique in its features to be scanned and used for identification.

### Example 3: Items Produced by 3D Printing

FIG. 5 shows schematically an item 27 in the process of manufacture by the process of 3D printing. In that process, a printer head 29 is moved between positions in a defined path in a plane and for each position is switched on or off under the control of a digital computer 31 so that respectively it either does or does not deposit a quantity of a substance such as a thermoplastic in a molten state. With suitable synchronization of operation and movements (indicated at 33) in a plane of the head 29, a layer of material of defined shape is added to the item 27. The head 29 is then moved to another plane and the process is repeated, so that a further layer is added, which may be of the same or a different shape. As numerous layers are added in this way, the item 27 is built up and eventually completed. Some of the individual deposits of material, in the completed item 27, lie nominally at a surface 35 of the item, which may be an internal or an external surface, external surfaces being preferred as they are easier to access when the item's identity is checked.

It is possible during such manufacture of an item by 3D printing to control the turning on and off of the head 29 in such a way that extra deposits are left on the surface 35 or omitted from it, so that the surface has slight excrescences or pits respectively, as indicated at 37. Such excrescences or pits 37—or both—can be incorporated in the item 27 and proportioned and/or positioned under control of the computer 31 so that the surface 35 has a unique marking thereon, or a shape or texture. This is additional to any texture that may be left by the 3D printing process itself.

The presence of a pit or excrescence 37 at any given location on the surface 35 may be made random, for example by determining whether the pit or excrescence 37 is or is not to be formed at that location by reference in the computer 31 to a random or pseudo-random number sequence. Therefore, an essentially unique mark or texture can be formed on surface 35.

Other random surface features than simple pits or excrescences may also be used to arrive at the final marking or texture of the surface. Any pit, excrescence or other feature may extend over more than one layer.

Generally, the layer thicknesses used in 3D printing are such that surface markings or textures formed in this way will be larger in scale than those exploited in Examples 1 and 2 above. However, the scale of such markings or textures may nevertheless be adequate for practical purposes in many cases, and particularly if any individual pits or excrescences are formed in one or two layers only. Further, there is the potential to use scanners with coarser resolution capabilities than would be required by the methods of examples 1 and 2, for example, a consumer-grade digital camera or even a mobile telephone with inbuilt digital camera.

After completion of 3D printing, the item 27, it (or a designated part of it) can be imaged at a suitable resolution (for example using the arrangement shown in FIG. 2) and the resulting image stored digitally. Alternatively, it is possible to track the positions (layers and coordinates within the layers) of the pits or excrescences 37 or other features that are formed in the item and record these in a database 39 instead of an image.

Note that instead of a random or pseudo-random sequence of numbers being used in the process above, it is possible to locate the pits and excrescences 37 or other features in a non-random way. This is a less preferred approach.

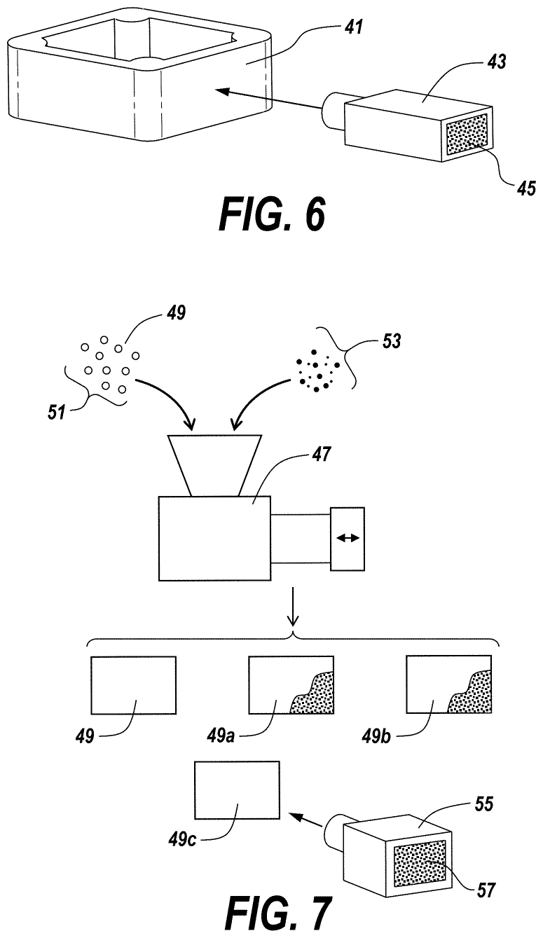

It is also possible with 3D printing to leave internal cavities in an item 41 (see FIG. 6) that is being made, by turning off the printer head at appropriate times. Such cavities may be located, sized and shaped as required, under computer control, so as to form a pattern that can be difficult to counterfeit. As in the case of surface pits, excrescences or other features, randomness can be added to produce a unique set and pattern of cavities. That pattern may be made manifest by various means, for example by the use of X-Ray means, or by ultrasonic imaging.

It is possible to stop printing at a designated layer containing such cavities, “dust” the surface with radio-opaque particles (e.g., iron filings in an item formed in a plastics material), so that they accumulate in the cavities, wipe the layer surface clean, and resume printing to complete the item. The pattern of cavities can then be X-Ray imaged when required.

FIG. 6 shows imaging of item 41, produced as described above, by a digital X-Ray scanner 43. Note that X Ray imaging can be achieved using the traditional technique in which an X-Ray source is placed on one side of an item and a sensor or sensing material is placed on the other. Today, there are also available devices—and device 43 is an example—relying on backscattering of X-Rays where both the X-Ray source and a sensor are incorporated in a single unit that can be placed on one side of the item whose internal features are to be examined. At least some of these can also display and store digital images as shown at 45 within the same unit. Such devices can be particularly convenient for the applications described herein.

Of course, attention must be given to structural integrity of items made in these ways, as appropriate for the application.

### Example 4: Cast and Moulded Items

FIG. 7 shows schematically an injection moulding machine 47 as widely used for the injection moulding of plastics items 49. Such machines are fed with plastic beads 51 that are melted and injected into a mould cavity (not shown). A method by which individual parts 49 produced by injection moulding can be made uniquely identifiable is to add to the supply of beads 51 a quantity of particles 53 that will be embedded and remain intact within each completed item 49, and whose presence, number and inherently random positions within the item 49 can be sensed, for example using an X-Ray imaging device 55 that produces a digital image of all or a part of the item, as shown at 57, and that can be stored. Regarding device 55, it is in some embodiments the same type as device 43. The particles 53 may be for example metallic filings or flakes, of a radio-opaque or -reflective material such as iron. Two of items 49 (49a and 49b) are shown partially cut away to show the presence of particles 53 therein.

Note that this approach can be applied to preforms to be used in blow moulding of containers such as PET bottles, leading to a pattern of embedded particles in the finished bottles.

Similarly, in items formed by casting (such as die casting or sand casting of metals) particles having a higher melting point than the material forming the item may be embedded at random positions in it so that they are randomly distributed as inclusions in the finished castings. To achieve this, the particles would be added to the melted casting metal before its placement in the mould or die. As with the injection moulding example above, the particles' number, and random positions may be sensed by, for example X-Ray means or any other suitable imaging technology.

### Example 5: Items to Which a Unique Mark is Added During or Following Manufacture

Instead of relying on inherent uniqueness arising from the materials or methods used in manufacture of an item, or markings added for other reasons than authentication, it is possible to rely on addition of a marking that is deliberately added, inherently unique or practically so, and difficult to counterfeit. (Serial numbers, barcodes and the like are markings in this category, but have the disadvantage that they are comparatively easy to duplicate.)

The key is applying a random marking which, if copied or duplicated would result in a copy marking dissimilar to the random marking when sensed to a sufficient precision—and therefore recognizable as belonging to a non-genuine item.

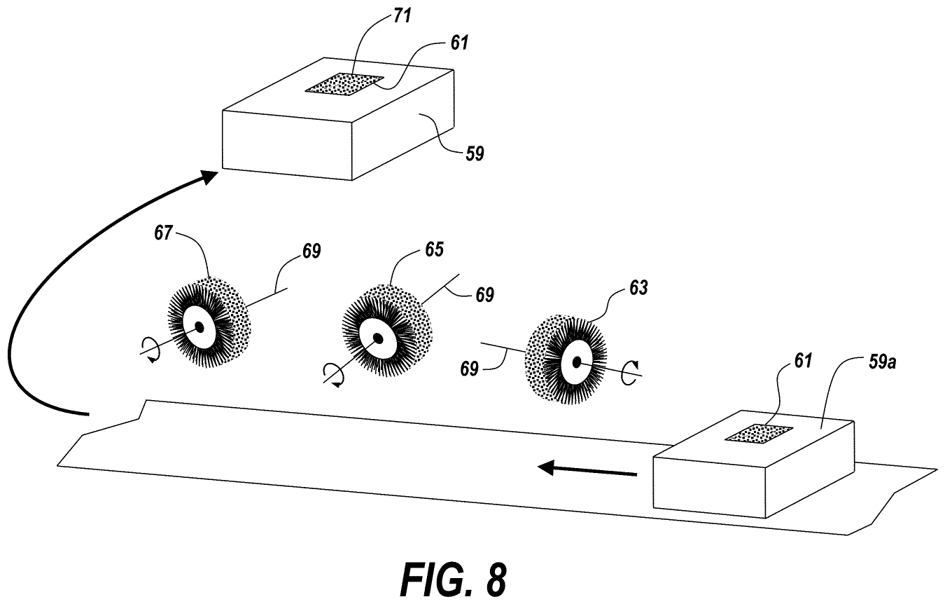

FIG. 8 shows a way of marking items 59 having a surface portion 61 that is amenable to being scratched or scuffed without affecting marketability, for example because a scratch or scuff may be placed in a location that is not seen when item 59 is in use.

Each Item 59 (such as item 59a) is moved past several rotary brushes 63, 65 and 67 whose bristles are chosen to be able to scratch, scuff or otherwise mark designated surface portion 61. The bristles are of varying length and scratching ability even within one of the wheels 63-67, so that the marks made on each successive item 59 by each of brushes 63, 65, 67 differs from the marks made on its predecessor and successor brushes. The brushes 63-67 have differing orientations of their axes of rotation 69 to further add to the difference between the marks produced on successive items 59. The brushes 63-67 are driven independently of each other and operate at different rotation speeds. All mark the item in particular surface portion 61. The effect of this arrangement is that each item 59 after passing brushes 63-67, bears a marking on its surface portion 61 that is a combination of effects from the several brushes 63-67, and that is for practical purposes unique. Such a marking 71 may be imaged, in the manner shown in FIG. 2, and the image stored for use in checking the identity of the item. The number of brushes 63-67 is shown as three, but any number could be used.

As an alternative approach (not shown), the brushes 63-67 in FIG. 8 could be replaced with several lasers powerful enough to mark (e.g., to burn or singe) a surface of an item. Such lasers would be moved in random ways (for example by being moved by actuators with random inputs), independently of each other, to apply a random, complex and difficult-to-counterfeit pattern to a manufactured item such as the items 59. As with brushes 63-67, the mark applied by each laser would be affected by the marks made by its predecessors and/or successors. Any number of lasers could be used. Brushes and lasers could also be used in combination.

Still another way to mark an item (not shown) is to apply to a surface portion (for example by spraying or with a brush or roller) a paint or ink or translucent adhesive that dries out and that contains particles flecks or flakes of a material that produces a random pattern on the surface. Such a paint may comprise a translucent or transparent resin with metallic flakes therein, for example a paint similar to that used to produce a “metallic” finish on motor vehicles. Another possibility is to provide a paint in which particles are partially mixed at the time of application, so that swirls of the particles remain in the applied and dried paint surface. Such a powder in some embodiments would be of a type that fluoresces in particular lighting conditions (e.g., ultraviolet light).

In either case, the surface portion would after application of the paint or ink or adhesive be scanned with an appropriate scanning device under appropriate lighting conditions, as shown in FIG. 2.

### Example 6: Precise Measurement of Item Characteristics

When any physical quantity is measured on a number of items, a range of values is obtained due to production variations, provided sufficient precision is used. Therefore, sufficiently precise measurement of one or more physical quantities associated with an item can allow, for practical purposes, unique identification of the item.

As examples, using suitable sensors, it is possible to measure the weight (as mentioned in relation to the method of FIG. 2), or a specific dimension, or the transparency (where applicable, for example in the case of a PET blow-moulded beverage container) of an item, for use in unique identification of the item. Color may also be used.

It is sometimes possible and practical to modify physical quantities deliberately, and this may enable a wider range and more favorable distribution of values of those quantities to be measured and used for identification. For example, where the quantity of a beverage in a beverage container is sufficiently controllable (subject to providing at least the labelled volume) the weight of the container and its contents or the level of contents in the container may be a useful quantity to use for unique identification purposes without requiring a production operation that is additional to normal operations.

In FIG. 2, item 1b is shown on a scale 13, which measures its weight, and the weight or a number code or the like related to the measurement may also be stored in the database along with the image data.

### Example 7: Electrical Component Characteristics

This example is applicable to devices including electrical circuitry. It is known that electrical components such as individual transistors, resistors, diodes and the like are subject to significant variations in their characteristics (for example transistor gain, resistance). Accordingly, it is found that measurements of such characteristics, if made with sufficient precision, will show variations from one device to the next. Such measurements may be made in-circuit and even though they will then be affected by the remainder of the circuit, will show variations from one device to the next.

Accordingly, where electronics devices are to be uniquely identified, the in-circuit measurement of an electronic characteristic of one or preferably several components can provide a way of distinguishing one device uniquely from others. Measured quantities can be combined numerically in any desired way to arrive at a unique metric.

### Further Embodiments

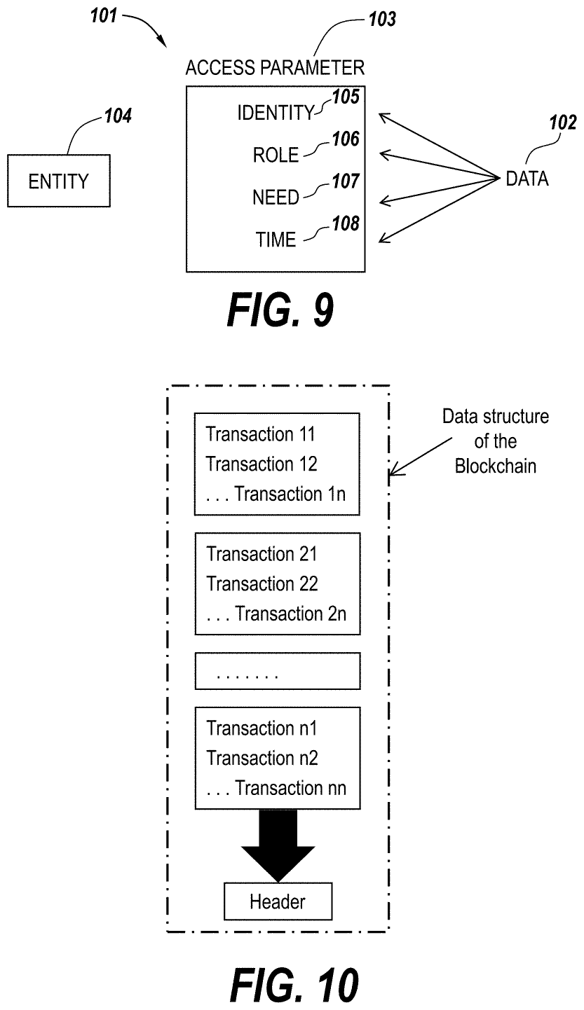

FIG. 9 is a block schematic diagram of a data access parameter system 101 according to a further embodiment of the invention.

The system 101 comprises a schema wherein access to the data 102 is a function of an access parameter 103. Examples of an access parameter include identity 105 of the entity 104 seeking access to the data 102; the role 106 of the entity 104; need 107 of the entity 104 or time 108.

### Block Chain Structures

FIG. 10 is a block schematic diagram of a blockchain data structure suitable for use with the data access parameter system of FIG. 9.

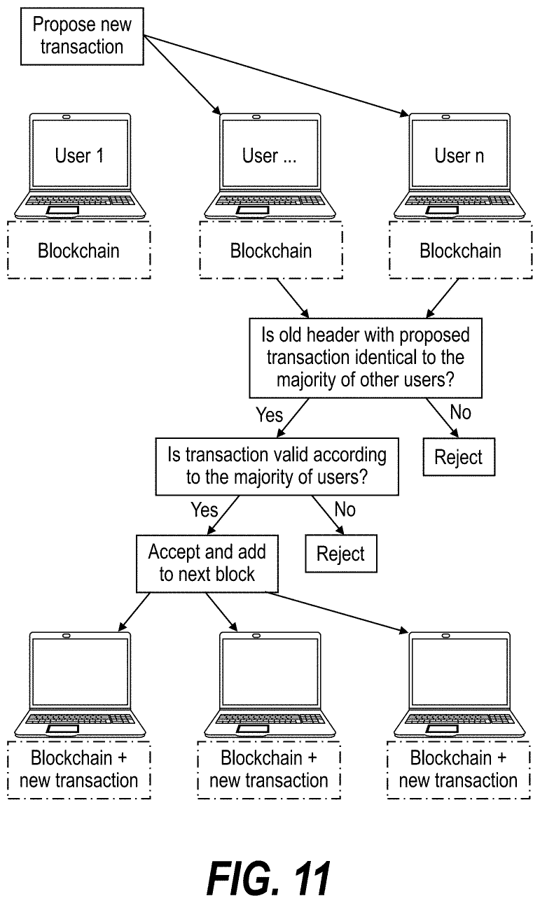

FIG. 11 is a logic flow diagram of a blockchain implementation of a system of FIG. 9.

Blockchain structures may be used to advantage with any of the above-described embodiments.

FIG. 10 is a diagram of an exemplary block chain data structure.

FIG. 11 illustrates diagrammatically use of the block chain data structure of FIG. 10.

With reference to FIGS. 10 and 11, Blockchain is a data structure and distributed record system, which seeks to provide a data structure and system which maintains a complete record of all transactions and minimizes risk of retrospective alterations, or double or identical transactions.

The data structure consists of a series of transactions grouped in blocks, which need to be verified before they are added to the chain. Rules may be set so no data is ever deleted, with the longest chain being taken to be the most recent, and so the chain records all transactions from its initiation in chronological order.

A copy of the chain is kept by all users, and so is a distributed record system. Before any transactions are added the majority of the users need to agree that the transaction is acceptable and then it is bundled with other acceptable transactions into a block, which is added to the chain. Each block has a header which can only be created knowing all the previous transactions. As a result, if a retrospective alteration is made the header will be incorrect and any new block proposed by that user will be rejected. The security of the system is further enhanced by having mathematical problems that can only be solved by trial and error, which use the header and must be solved and then verified by the majority of other users before a block is accepted into the chain by all users. As long as there are more genuine users than coordinated attackers trying to alter the chain then the chain will be secure. There may be other methods used to determine the veracity of a block of data, this may include voting or consent processes where parties with a stake in the transaction or related transactions or in the chain itself are granted ‘voting’ rights. Another process may involve a random or systematized voting or approval system where the validity of the block of data is approved in accordance with a set of protocols agreed by those with a stake in the veracity of the chain of data.

In a more particular form, each block includes verified transactions and the blockchain maintains a ledger all prior transactions. The blockchain is duplicated by all the computers on a network.

The first block in the chain is known as the Genesis block and new blocks can be added in linear and chronological order. From any given block in the chain the information of this genesis block and all blocks that led back to this one can be retrieved. A blockchain is essentially numerous blocks connected through hash chaining where each block is comprised of the following: Timestamp: provides proof that the data in a block existed at a particular time Previous Hash: Essentially a pointer to the previous block Merkle Hash: Summary of all executed transactions Nonce: Individual blocks identity and is an arbitrary number which can only be used once.

The blockchain is managed by a network of distributed nodes where each node contains a copy of the entire blockchain. Each node in the network can add blocks to the chain, where every node is adding blocks at the same point in the chain at the same time. The more nodes that comprise the network the harder it is to disrupt the storage of the blockchain. Unlike centralized systems which rely on a single authority, there is no single point of failure in these distributed nodes network. If you change the content of a block, you change its Hash.

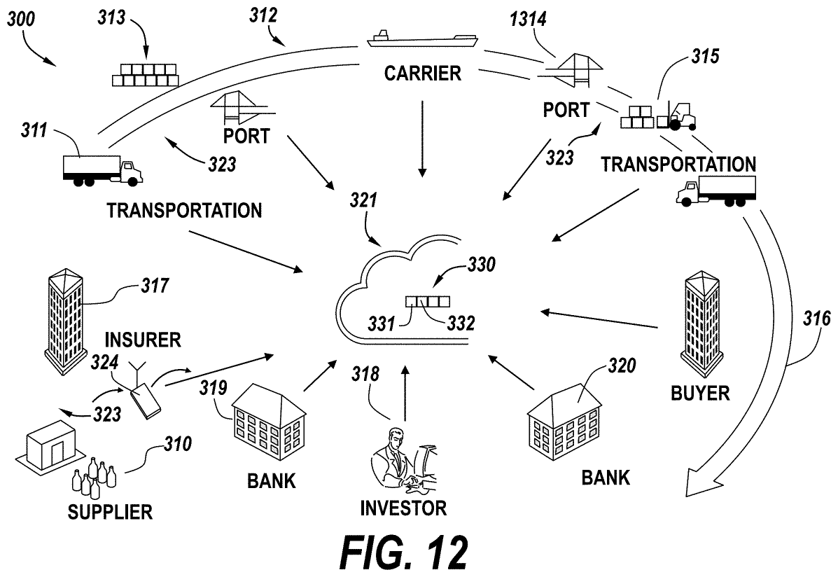

FIG. 12 is a schematic diagram of the system of FIG. 9 applied in a logistics context.

FIG. 12 illustrates yet a further exemplary embodiment of the system of the present invention applied in the context of selective data retention and selective data availability. In this instance the database 321 is supported by a reception of extended granular data 322 combined with additional data feeds in the data structures of the database 321 whereby the data records are segmented whereby selected portions of data record 330 are available to users of the system 300 on a selective basis. So, for example, a first user may be able to access only record 331 of the data structure 330 whilst another user may be permitted to access records 331 and 332. In some forms the accessibility to a record will be based on an additional parameter to identity. It may include time for example. Alternatively, or in addition it may be based on the location of an item along the chain. That is data in selected fields may be available only whilst an item is, for example, located between a first point of transfer and a second point of transfer.

With particular reference to the arrangement of FIG. 12, and by way of exemplification of it; the system, 300, makes use of information stored progressively in a database—in preferred forms as a distributed ledger—more preferably of the Blockchain type. The purpose of the system is to verify the contents, security and location of a shipment of items (“System”). It uses information gathered as an item moves along a custodial chain of handlers who pack, store or transport that particular item. It does not matter to the System how many custodians hold and later transfer the item.

The System is concerned with the following information (“Shipment Information”): certainty about the identity of one or more items that may be grouped and packed inside a carton and/or pallet which are then placed into a shipping container either for land, sea, rail or air freight; In one form each item is identified uniquely by the item identification and tracking system described earlier with reference to FIGS. 1A to 8 gathering, storing, disseminating and using information about the container and its contents as a whole;
certainty that the content of the container remains intact or that any changes to those items are known; and certainty about the location of the container.

### External Use of the System's Information

The System allows its customers to access the Shipment Information and to make commercial decisions based on that information.

The commercial decisions may relate to decisions related to finance, insurance, legal, or other business issues.

The System provides information about ‘what’ is ‘where’ and ‘when’. The System also confirms that the ‘what’ remains unchanged during the movement of the container along the supply chain.

### Contract Data Construct

A contract data construct is a term given to a data construct that is stored on the database, 321. Data entered into the data construct, 330, is shaped by legal processes and concepts to form a method to partly or fully automate contracts (“Smart Contract”). That automation capability may mean that a number of parties are involved in the contract.

Those parties to the Smart Contract may also elect to share some or all the data they individually enter. The data may be entered into the hand-held data acquisition device, 324, at points along the supply chain, for on communication to the database, 321. This information sharing may eliminate information duplication as it may eliminate or minimize the repetitive input of similar or identical data by each party into their own data systems.

The concept of Smart Contracts may be reliant on the existence of certain information that triggers the contract's specified action. In the case of a Smart Contract for the supply of goods, the contract's provisions may be triggered and the ownership of the goods may then pass from the seller to the buyer. Intrinsic to that change of ownership may be the change in liability and insurance risks that may happen at the same time.

Any insurers, banks, law firms and accountants that are party to the Smart Contract will have an interest in the effect of the provisions of the contract being triggered in ownership and liability be passed from the seller to the buyer.

Other parties who may participate in a Smart Contract and the related supply chain would be packaging companies, manufacturers, warehouses, logistics companies and brokers, trucking companies, distributors and stores. Depending on the mode of transport, rail yards, railways, shipping lines, sea ports, airlines or airports may also be involved in a particular Smart Contract.

When a Smart Contract's provisions are activated, that trigger is often described as requiring third party information that establishes the relevant facts that cause the trigger to be activated.

Because the System has gathered and stored the data on the supply chain movement of a container, the System can be interrogated by a user which is either a Smart Contract application or the operator of a smart contract application.

### Example

A shipment of wine is to be sold by the seller to a buyer in China. Under the sale terms, payment for the shipment of wine is to be made when the wine is landed in Shanghai.

The shipment is a DES shipment (Delivered Ex Ship). In this type of transaction, it is the seller's responsibility to get the goods to the port of destination or to engage the forwarder to move the cargo to the port of destination uncleared. ‘Delivery’ occurs when the goods arrive in the Shanghai port.

The shipment is one container filled with the Seller's wine. The wine is packed into cartons. Cartons are loaded on pallets. Pallets are loaded into the container and the container is sealed.

The Container is provided with a unique identifying number which may or may not be an encrypted identifier. In an alternative form the Container is identified uniquely by the item identification and tracking system described earlier with reference to FIGS. 1A to 8.

The Seller has engaged the services of a freight forwarding company to transport the Container to the Buyer. The freight forward arranges for a trucking company to collect the Container from the Seller's premises.

The trucking company collects the Container and transports it to the port. The port takes custody of the Container which is subsequently loaded onto a ship. The ship transports the Container to Shanghai.

The parties involved in the relevant smart contract are the Seller, the freight forwarding company, the trucking company, the port, the shipping company and the receiving port and the Buyer. The accountants, bankers, insurers and lawyers for all the various parties may also have an interest in the Smart Contract and the progress of the shipment.

The point of delivery may vary from contract to contract depending on the terms agreed between the respective Seller and Buyer. In some instances, the point where ownership and liability move could take place very early in the supply chain. Regardless of the terms, the information stored in the system on a distributed ledger could be accessed by the Smart Contract to determine if the trigger point for a particular transaction has been reached.

### Auditing

An auditor or any other interested third party may use the application to interrogate the database, 321, to determine the status of a given Item. This data would include any information recorded on the database in relation to the Item's origins, rights limits or the Item's chain of custody.

### Sealing Certainty

In the case that customs or other regulatory authority needs to validly access the Container and the device or technology, the system allows them to take custody of the item, and this is recorded on the database. As a result, a degree of certainty regarding when a container was opened may be obtained.

### Application of Aggregation Methods in the Agricultural Industry

In instances where the identity of a specific plant (or tree) is useful, a unique identity may be applied to each ‘item’ i.e., plant. The life cycle of that item may then be tracked as it matures and is finally processed, distributed, and sold.

The lifecycle may be tracked: germination; seedling; advancement; maturation; flowering; and harvesting. This may provide certainty about the plant's origins and attributes.

Influences on the plant's history, growing conditions, and quality attributes may also be recorded against this growth record. The use of fertilisers or pesticides may be useful information relevant to the producer, vendors, consumers, government authorities, or others.

An individual plant's information may be aggregated into categories such as growing room, plot, field or crop. Such information may be based on certain criteria e.g., germination date; harvesting period; or sub-species grouping.

Disaggregation may also be possible as a particular batch may be identified down through various data layers such as: a particular batch; packing date, a particular carton, and then down to an individual item.

Similarly, the life cycle of livestock may be tracked from birth, to processing, to consumption. Influences such as medication, drenching, stocking location, environmental conditions etc. may be recorded and tracked against a unique identity given at birth.

An individual animal's data may be aggregated with the flock, mob, or herd information. It may, when subsequently required, be disaggregated as the individual animal is slaughtered and processed into individually identified meat products.

### 3D Matrix

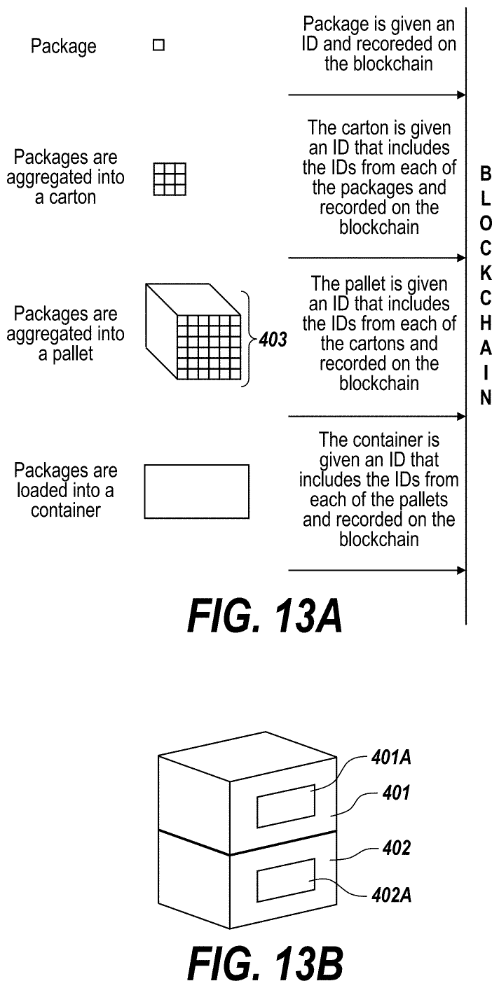

With reference to FIG. 13A and FIG. 13B, aspects of the previously described embodiments may be applied in a spatial context.

In this instance packages 401, 402 . . . are stacked in a three-dimensional array aggregated onto a pallet 403.

In this instance each package 401, 402 is uniquely identified by an RFID tag 401A, 402A respectively.

In an alternative form each package 401, 402 may be uniquely identified by physical characteristics as previously described and without the need to affix a separate unique identifier device—whether in the form of an RFID tag or otherwise.

The entirely of the pallet 403 is scanned in order to store the array of the identifiers as a three-dimensional matrix.

At subsequent points along a supply chain the pallet 403 may be scanned again and a three-dimensional matrix of identifiers comprising the pallet 403 created as at that point along the supply chain. If the three-dimensional matrix at the subsequent point does not match with the original three-dimensional matrix it may follow that tampering or replacement or counterfeiting has occurred.

Stated another way, a scan of the pallet 403 and determining a matrix of the various identifiers 401, 402 and their spatial relationship to each other within the various cartons packed into the pallet is a form of unique identification of the pallet 403 according to this embodiment. Any variation in that 3D matrix may be an indicator of tampering, replacement of items, or counterfeiting. The matrix may be created utilizing one or other of the identifier methodologies describe earlier in this specification. In one form this may be by use of RFID, NFC or similar ‘signal’ technologies.

### Authentication

In preferred forms data pertaining to unique identification of elements may be subject to use of authentication techniques.

In one form a unique identifier may be encoded with reference to a key.

One particular form of key may be PKI key technology.

More particularly encryption based on RSA technology which utilizes a public key to encrypt the unique identifier and a private key to subsequently decrypt the identifier may be utilized.

### INDUSTRIAL APPLICATION

Embodiments of the invention may be applied in order to accord an identifier to a manufactured item and then to track the manufactured item as it is transported from one location to another.

Embodiments of the invention, as described by way of example above may be utilized with advantage in supply chain management with particular reference to be able to identify anomalies in the chain such as the introduction of non-authorized goods in the form of counterfeit goods.

Now follows a description of an information system for item verification the subject of international patent application PCT/AU2017/000078. The above-described item identification and tracking system may be applied to the following described information system for item verification.

### Information System for Item Verification

Embodiments of the present invention relate to a system, and associated method for using the system, in order to track items of stock and record details of packing and unpacking of items in a supply chain.

In preferred forms embodiments of the system are capable of allowing multiple levels of packing assigning tags to each new packaging level. For example, the item of stock is a single package with a Tag ID, this is then packed in a carton which is given a carton ID, the pallets are then packed into a pallet which is given a pallet ID, and the pallets are packed into a container which is given a container ID. To move stock in a packed or unpacked form it is necessary to assign a custodian. The custodial chain starts when the manufacturer hands custody to the first custodian who in turn passes custody along the supply chain. Custodians may be freight forwarders, rail, trucking, port, container terminal, and warehouse operators or other allied members of the supply chain who move goods along the chain from the factory to the store shelf. The stock is transported and passed along the supply chain until it eventually reaches the shop owner who fully unpacks and displays the stock.

To record the movement of stock, it is necessary to have a database of all items of stock, the way in which they are packaged, and their transportation. This database needs to be shared by all users and each user allowed to update the database in accordance with their position. In one form the database may be implemented by a Blockchain structure as a distributed database system intended to maintain a complete record and be secure against alteration.

To record the packing and then unpacking of the items of stock, as well as transfer of packed items to a new custodian the present system treats each action as a transaction recording this in a database that follows a blockchain structure. Each action is a transaction recorded permanently. Each user, be it the manufacturer, a supply chain participant, wholesaler, or a store, may (but is not required) to keep a copy of the database following the distributed ledger feature of blockchain. The reason to use a distributed ledger when tracking items of stock is to allow a validation of the path that any particular item has followed and to minimize the risk of tampering (or identify it with a faulty record) anywhere along the chain. Any alteration of the blockchain will result in an error message and the stock affected by the identified alteration can be removed from circulation for inspection.

By maintaining a complete record of the movement of any item of stock using the blockchain structure means that a customer can trace back the movement of any item of stock and so have confidence that non-genuine items are not being sold or resold.

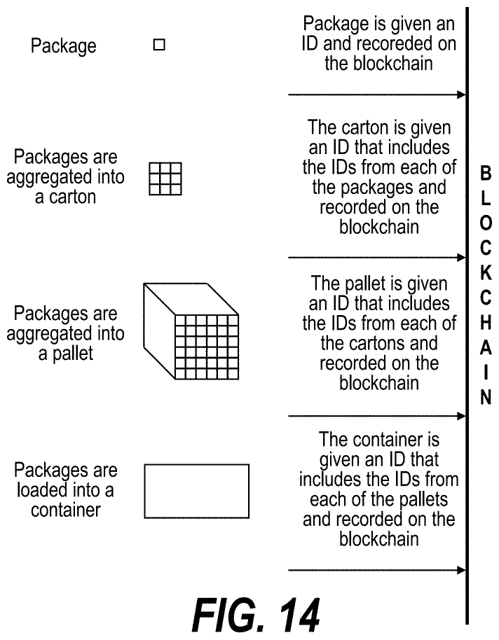

With reference to FIGS. 14-16 the system 1010 may operate conceptually as follows:

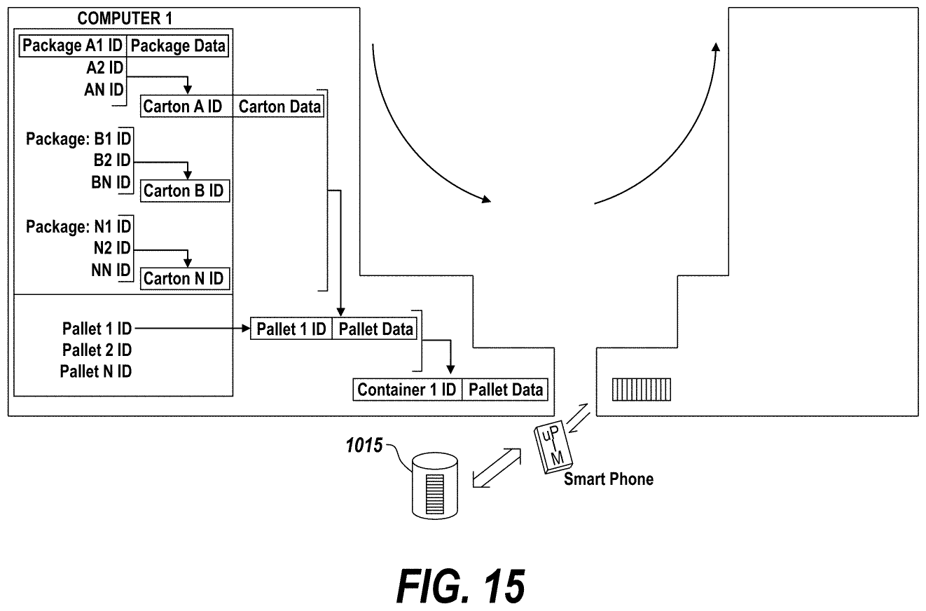

With reference to FIG. 15 in one form the system 1010 involves, broadly, a “packing” step 1011, a transfer step 1012 and an unpacking step 1013.

Relevant data 1014 is recorded in and referenced against database 1015.

The relevant data 1014 is recognized and interrogated by digital devices during the various steps. In one form the digital devices take the form of smartphones or tablets 1016.

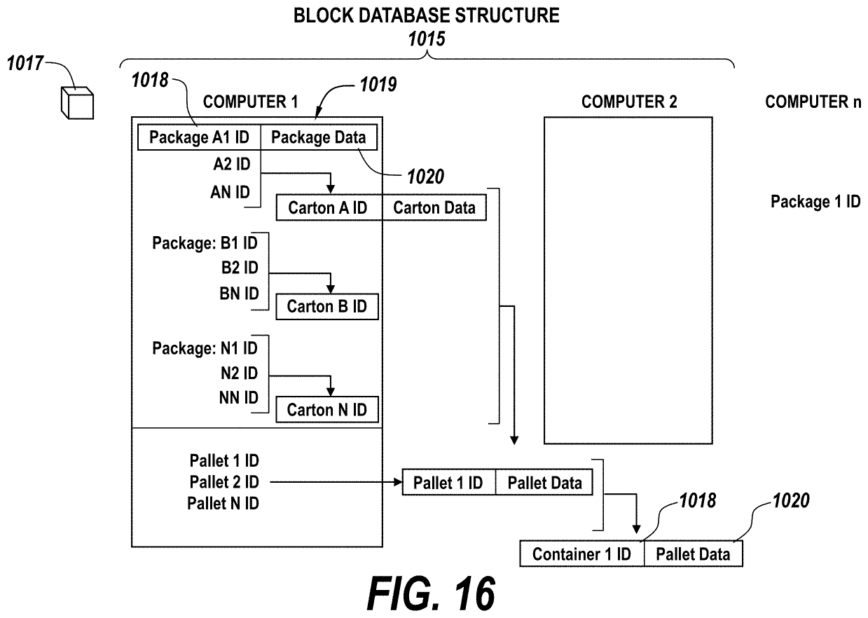

FIG. 16 illustrates in detail one example of a packing step 1011.

In this instance an element 1017 will have associated physically with it an element identifier 1018. The element identifier 1018 will be placed in a record 1019 which also includes associated data 1020. The associated data may relate to the nature of the packaging of the element and in subsequent steps in the supply chain may relate to events that occur during transport of the element 1017 either individually or as part of a package component.

In that regard, with reference to FIG. 15 the elements 1018 may be encapsulated in a carton which in turn may be encapsulated in a carton which may in turn be encapsulated in a container for conveyance.

The container may be transported involving various events including inspection by Customs and the like before it eventually experiences an unpacking step 1013 wherein a reverse process to that illustrated in FIG. 15 occurs.

At steps along the way, a digital device 1016 may interrogate the element identifier that is associated physically with the element and then check against data records in database 1015.

For the purposes of this patent when we refer to Blockchain, we will mean any data structure in the form of a distributed ledger (whether a centralized, decentralized or a hybrid ledger is implemented and operated) including any adaptation or derivation of such a concept. As an example of the flexibility of this definition, a Blockchain may involve a private blockchain combined with a public ledger.

An individual item, whether each is a discrete item, object or a product (“Item”), can have its authenticity and origin proven when verification information (“Item ID”) is displayed or made readable or detectable, within, on or about the Item. The relevant Item's Item ID is then read, checked, matched or otherwise interrogated (“Checked”) against the data stored on the Blockchain.

The Item ID may be in the form of a chemical signal, embedded chip, bar code, QR code, signal or any other means (“Code”) that will enable the verification information to be extracted, read, detected or to be Checked by any other means.

Throughout this document we will generically refer to placement of the Code in, on or about an Item as being a process where a marker of the individual Item ID would be attached to the relevant Item.

When the Item is Checked, the Code will be checked and verified through the use of an application which may be displayed or deployed on any suitable device (“Application”). The Application will recognize various functions for which a user may wish to have the Code Checked.

The Originator (defined below) will have the option of bundling the Item with other similar Items (with each Item having its own respective Item ID). Equally the Originator may elect to distribute an Item in an unbundled format. In that case, the System would be adapted to still provide verification in relation to the lone Item.

Some examples of those functions would be:

Originator: The person or entity that holds the authority that brings the item's ID into existence and places that Item ID onto the Blockchain.

Custodian: The person or entity that receives the custody of an Item when the Originator transfers custody of the Item through the Blockchain to the Custodian. A Custodian will use the Application to interact with the Blockchain to either accept or transfer the custody of an Item. A Custodian may at any time, in turn, transfer the custody of an Item to another Custodian who inherits the same right to transfer custody of the Item to yet another Custodian.

Monitor: At any point in time, the Blockchain may be Checked to determine the current custodial status of the Item. A Monitor may be any person interested in the custody of the Item, such as a transporter, shipping agent, ship's crew, port authority, customs officer, warehouse staff etc.

Seller: The Seller will use the Application to interact with and Check data on the Blockchain. The Seller also holds the rights and power to transfer the custody of an Item to another Custodian. It is acknowledged that ownership may not change when the Item is transferred from one Custodian to another. In certain circumstances, the act of sale is akin to the transfer of custody in return for payment. The Seller will inform the Blockchain that the custody (or ownership) of the Item is being transferred to the new Custodian. Whether that person receiving custody of the Item is a new Custodian or a buyer does not matter for the purposes of the System—unless the buyer is a consumer (“Consumer”). If the buyer is a Consumer, a more detailed level of interaction with the Application and the Blockchain will take place. The distinction of how a Consumer interacts with the Application will be explained in more detail later in this document. When any transfer takes place, matters such as agency, custodial rights, escrow, title and ownership will be determined by normal legal methods and will sit outside the System. The System is merely a means of recording of a custodial chain. Neither the Application, nor the System, alters the prevailing legal rights.

If the Item was to be registered on a personal property security register or any other external registry system, the act of registration may be recorded on the Blockchain.

Consumer: The Blockchain can be Checked by the Consumer using the Application. The Consumer has the same rights and power to accept the custody of an Item from another Custodian (who in this case of the sale of the Item would be the seller). Ownership will transfer when the Item is transferred to the buyer/Consumer in accordance with the settled law of the applicable jurisdiction.

The buyer/Consumer will also enjoy title to the Item subject to any rights or limitations that may have been imposed by the Originator at the time the Item was originated and registered on the Blockchain.

An example of such a right would be an expiry date for the Item. After a certain date, the Item may no longer be validly transferred and the Item would be denoted on the Blockchain (if a Check was conducted after that date) as being an expired Item.

Auditor: An auditor or any other interested third party may use the application to interrogate the Blockchain to determine the status of a given Item. This data would include any information recorded on the Blockchain in relation to the Item's origins, rights limits or the Item's chain of custody.

### Item ID Origination

The power to originate an Item ID is open to any person who wishes to assume the role of Originator.

Some Originator's may have more complex operational requirements where they wish to authorize members of their approved network to interact with an Item or Items by directly interacting with the data record of the Item/s placed on the Blockchain.

Such authorized network members may include, but not be limited to: transport entities, shipping agents, vessels, warehouse operators, distributors, retailers and public authorities such as customs and quarantine officers.

The Originator may elect to establish a register of approved network members. The register may be a ‘central registry’ function conducted by the Originator or a trusted third party. The public keys of each network member may be recorded on the Blockchain against the Item ID of each relevant Item. Of course, this authorization matrix may be segregated, varied or adapted in any way that is preferred by the Originator. The rules (in effect the devolved authority to validly deal with an Item) may be varied for a certain Item or group of Items as best suits the Originator's requirements.

Such a register may be designed to be a further protective measure to limit the power of other persons to validly interact with an Item or indeed, a shipment of Items. Restricting the valid access to a pre-approved network of authorized members may better protect and maintain control over the provenance of an Item. Network members would be authorized to interact with an Item in an approved manner that does not break the custodial chain.

Example: One example would be where a container was being shipped from the factory of the Originator overseas to Australia.

The Originator may establish a set of rules. Those rules may have the flexibility to address less common or infrequent occurrences. That flexibility would maintain the chain of custody and the chain of custody would not be broken if the Australian customs or quarantine authorities opened the container (an Item) for inspection. The authorities may even exercise their discretion to open sub-Items (such as pallets, cartons or packets) as will be outlined in a later example. The rules may have the flexibility to address such events.

The power issued to the Australian officers would be to use the relevant authority's private key to break a seal (which would otherwise alter the custodial chain if a seal was broken by an unauthorized third party).

The authorities may also have the power to “reseal” (for the purposes of the custodial chain) an Item. The power/authority to reseal an Item may be a power the Originator restricts and does not grant to other network members. Equally the authority to validly unpack an Item may also be restricted. (e.g., a retailer may only have the authority to validly open a carton, while the authority to open a container or pallet may be restricted to an authorized distributor who is a network member authorized to exercise that power).

An originator may also sub-delegate certain powers. (e.g., a distributor may be empowered to add or remove authorized retailers from the network of members). In such a case the power granted by the Originator may limit the power a distributor can exercise to only relate to a carton. So, a retailer can validly open a carton and display the items on the self for sale.

Devolving this power may, in some circumstances, yield security benefits as the distributor may authorize a specific retailer to be the only entity validly entitled to open an individual carton (Item).

Local knowledge and regular interaction between distributors and retailers may mean this level of control is a useful option the Originator may utilize.

The shipment process will be explained (along with a usage example) in greater detail below.

### Concepts

The System may be deployed in many varying ways. One way would be to gather Items together in a small group. A number of small groups would then be combined or bundled into a larger group for ease of handling or otherwise.

A number of large groups would then be bundled together into an even larger group. A number of even larger groups would then be bundled together in a much larger group. This grouping process may continue to any number of levels.

At each level the individual group would receive its own Item ID. For the sake of clarity, it is important to note that a discrete Item ID would be assigned at each grouping level.

When the custody of a group of Items is transferred from one party to another, the transferor must authorize that transfer by pushing the custodial authority to the transferee. That transfer would be performed through the Blockchain.

The transferor would use the transferor's own private key to inform the Blockchain that a transfer of the custody of the particular Item ID was to be transferred to the transferee's public key. This process would be the same whether the Item ID pertained to an individual Item or a given grouping level of Items.

### Origination and Distribution Example

With reference to FIG. 14, a pharmaceutical manufacturer (an Originator) may at the end of the tablet manufacturing assembly line, bundle a certain number of tablets. In such an example, this bundling may be in the form or tablets being encased in a bottle, tablets being encased in foil sheets with those sheets then being placed into a package. Of course, the bundling method or process may be varied as required.

Package: The bundled tablets (bundled into a package for the purposes of this example) would then be assigned an Item ID by the manufacturer/Originator using the Originator's private key held by the manufacturer. A marker of that Item ID would be attached by the Originator to the Item. Details of the Item ID would then be entered into the relevant new Item's (package's) token on the Blockchain using the Application. In this way, the Item would be created and the Item would become an active element or token on the Blockchain.

Carton: The Originator may then bundle any number of packets (each packet bearing its own unique Item ID) into a sealed carton. Once the carton is sealed, the Originator would then assign the carton an Item ID. A marker of that Item ID would be attached by the Originator to the Item. The relevant data would be added to the token of the new Item (carton) on the Blockchain using the Application. The data stored on the Blockchain in relation to that Item ID would denote that this Item was sealed with each of the relevant Items (in this case packets) stored inside that Item (in this case a carton).

Pallet: At the next step of the packaging process, the Originator may bundle a number of cartons onto a pallet and the pallet and piled cartons may then be encased in plastic or otherwise be secured and sealed. Once the pallet is sealed, the Originator would then assign the pallet an Item ID.

A marker of that Item ID would be attached by the Originator to this newly created Item. The relevant data would be added to the token of the new Item (pallet) on the Blockchain using the Application. The data stored on the Blockchain in relation to that Item ID would denote that this Item was sealed with each of the relevant Items (in this case cartons) stored inside that Item (in this case a pallet).

Container: At the next step of the packaging process, the Originator may bundle a number of pallets into a container and the container may then be secured and sealed. When the container is sealed, the Originator would then assign the container an Item ID. A marker of that Item ID would be attached by the Originator to the Item. The relevant data would be added to the token of the new Item (container) on the Blockchain using the Application. The data stored on the Blockchain in relation to that Item ID would denote that this Item was sealed with each of the relevant Items (in this case pallets) stored inside that Item (in this case a container).

There is no requirement for any particular packaging methodology to be followed. The principle is simply that:

each Item bears its own Item ID;

a marker of that Item ID would be attached by the Originator to the Item the token of the new Item on the Blockchain would have the updated data stored using the Application;

a bundled group of items is assigned its own Item ID;

each bundled group would be noted as holding a grouping of the next smaller level of bundled Items (a container would hold x pallets, a pallet would hold x cartons, a carton would hold x packets) with all those details being recorded on the Blockchain).

### Origination Rights

At the end of the packaging process, the Originator would use the Application to denote on the item's token on the Blockchain (in this case the container's token) that the container was validly originated by the Originator (including all of the individual Items that comprise the container's contents).

As stated above, the token would also contain any other rights, limits or conditions that the Originator elected to ascribe to that Item or any individual Item (or sub-item) in the chain of Items. The rights, limits or conditions may be ascribed down to the smallest bundling level of Items that had been assigned an Item ID.

### Custodial Chain Example

Upon the completion of the packing process the Item (in this case a container) would be formally released for distribution by the Originator. The Originator would use the Application to record that release on the Blockchain.

In practice, the release would take place when custody of the Item was first transferred. That transfer would then be noted on the token for that Item on the Blockchain. It may even be a transfer from the assembly line to the Originator's warehouse facility to await shipping.

### Distribution

The private key of the Originator would transfer custody of the token (being the Item ID) on the Blockchain to the transferee (in this case the transport company). It is a fundamental component of this system that only the Originator is able to conduct the first transfer of custody to the transferee. Custody must be pushed by the transferor; it can't be pulled by the transferee.

The transport company will, in turn deliver the Item to the port company with both the transferor (transport company) and the transferee (port company) using the Application to inform and update the Item's token on the Blockchain regarding the change of custody. The rights and obligations of the custody will take effect as it would under any other custody transfer process.

The custodial chain will continue through any number of transfer points, from port company to ship, from ship to port company at the ship's destination, from port company to transport company and from transport company to the distributor's warehouse.

At all stages of the supply chain process, the Item (in this case the container) will remain sealed.

When the seal of the Item (container) is broken the person breaking the seal must use the application to update the Item's token on the Blockchain.

### Inspection

Monitors such as customs officials will have the right to inspect and validly open, inspect and re-seal any container (and any sub-bundles). That right may be granted by the Originator at the time the goods were packaged or through any valid update to the Item's data on the Blockchain.

The Originator will be informed of such changes (as much as is permitted by law) through updates on the Item's record on the Blockchain. If any discrepancy in the custodial chain is detected by the Originator, then all of the affected items may be withdrawn from sale.

### Unpacking

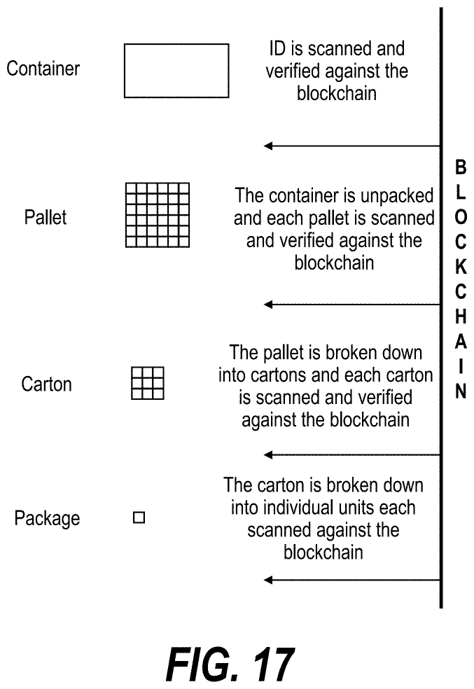

With reference to FIG. 17, the unpacking process may then begin. In that process, an Item (container) will be noted on the Blockchain as having been unsealed and the token of the smaller item level (pallet) would then be activated on the Blockchain. In this case activation means that the Items at that level of the packaging process may then be enabled to have their custody transferred.

A custodial chain for an individual pallet may then occur. Any changes in custody would again take place by both the transferee and the transferor using the application to interact with the Blockchain. There may be any number of changes in the custody of the Item (pallet) with each transfer being recorded on the Blockchain.

The seal of the pallet may then be broken. A similar unpacking process would be noted through the Application with the affected tokens being updated on the Blockchain. This means the tokens of the individual cartons would be activated, thus enabling custody of an individual carton to be transferred. There may be any number of changes in the custody of the enclosed Items (cartons) with each transfer (of a carton) being recorded on the Blockchain.

A transport company may, in turn, deliver an individual carton to the pharmacy. Both the transport company and the pharmacy would then use the application to update the status of the Item (carton) status on the Blockchain.

### Display for Sale

The pharmacy would then use the Application to update the carton's token on the Blockchain. The act of breaking the seal of the carton would, in accordance with the rules established by the Originator during the packaging process, activate the item to be validly ready for sale.

The Items would be readied for display on the shelves of the pharmacy. The pharmacy would use the Application to update the token of each packet of tablets on the Blockchain. It would be denoted on the Blockchain that each Item (packet), bearing its own Item ID, would now be validly authorized for sale to a Consumer.

The pharmacy would place and display for sale the individual Items (packets) on the shelves of the pharmacy.

### Consumer Protection

A Consumer shopping in the pharmacy can then use the Application to verify the authenticity of the Item (packet) displayed for sale by the pharmacy.

### Verification

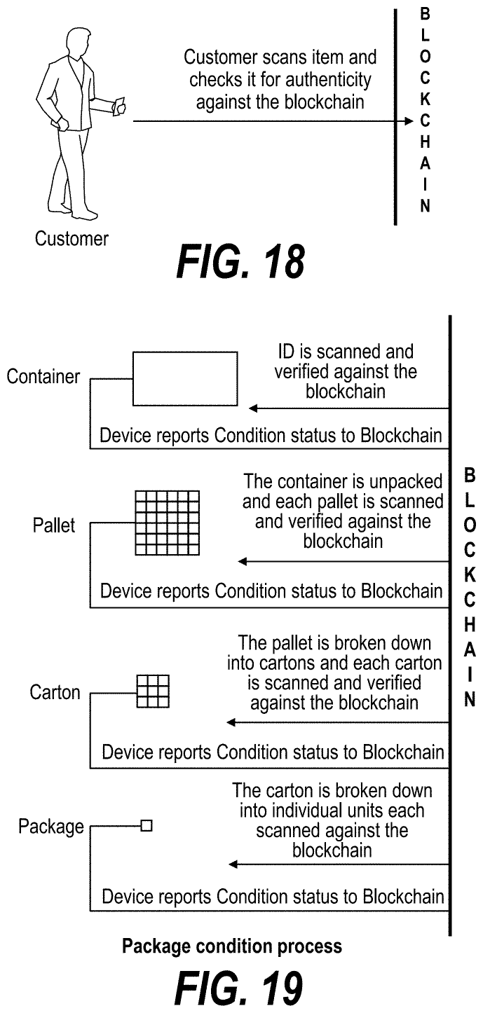

With reference to FIG. 18, the Consumer will use the Application to read the Item ID of the packet they are considering purchasing. The Application will analyze the data stored on the Blockchain in relation to that individual Item.

The consideration performed during the analysis will include, but is not limited to, an analysis of:

whether the Originator is an entity registered with the Application;
whether the valid private key of the Originator was used;
whether the Originator has given notice to the Application (through the Blockchain) that an irregularity has occurred in the packaging or shipping process; whether the Originator has recalled the product and the Item has been withdrawn from sale;
whether there have been any irregularities detected by the Application (through the Blockchain being Checked) or reported by the Originator or any third party during the supply process;
whether the pharmacy, being the base (or sales level) unpacker in the custodial chain has authorized the product (by using the Application to verify the product was authorized for sale when it was placed on the pharmacy's display shelf);
this authorization step may or may not be required.
whether the token for the individual Item has previously been spent (double spends of an Item's token will not by permitted by the Application) e.g., by the item having been sold through a point-of-sale device or any other process that means the item has reached the end of the supply chain for that particular item.

### Verification Confirmation

If the analysis of the data stored on the Blockchain in relation to the relevant Item ID does not detect any anomaly, the Consumer will be informed that no defect in the title of the Item was detected on the Blockchain. A message (or image such as a tick) will be displayed on the Application.

### Verification Rejection

If the analysis of the data stored on the Blockchain in relation to the relevant Item ID does detect an anomaly, including if the product has been recalled or withdrawn from sale, a message (or image such as a cross) will be displayed on the Application.

### Point of Sale

If the verification was confirmed, the Consumer will then take the Item to the counter to offer to purchase the Item. At the counter, the pharmacy will be entitled to sell/transfer the Item to the Consumer.

The pharmacy/seller will use the Application to transfer/sell the Item to the Consumer.

In order to sell the Item, the pharmacy in a preferred form may be the holder of the correct private key associated with the already verified custodial chain for that Item.

That same private key must have been used to designate the product as being ready for sale when the Item was placed on the display shelf. That display for sale process, will be enabled if the same private key was used to update the Blockchain when the seal of the carton was broken.

### Consumer Warnings

The Consumer must be informed to only buy an unopened packet (as is standard practice).

The Consumer must be warned that while an individual packet may be a copy, no more than one packet bearing an individual Item ID can ever be validly sold. The limit to only sell one counterfeit item is a very unattractive proposition for a counterfeiter. The amount of effort and cost that would have to be expended per item would be a strong disincentive against copying.

### Double Spends Prevented

Further protection for the Consumer will be provided as the Application will check if any packet from the respective carton has ever been sold in another location. If that is the case, the Consumer will be warned that the Item ID has not been satisfactorily verified (if this is a setting or condition chosen by the Originator).

### Anomaly Reports

If any anomaly related to a particular Item ID is detected by the Application, the Application will update the tokens of all Items in the next bundling level up (in this case a carton). That update will mark all unused Items in that bundle (carton) as being suspect due to a detected anomaly. The upwards notification of the anomaly would continue to cascade up the supply chain in accordance with any notification rules established by the Originator at the time the relevant Item was originated.

The Originator would receive direct notice of the anomaly in accordance with the notification settings set by the Originator.

### Anomaly Consequences

As an added measure of Consumer protection, once an anomaly is detected, all related (carton level) Items will no longer be saleable (if that is the anomaly response selected by the Originator).

Another feature is that if an anomaly is reported on one item, then that anomaly report should affect the associated items in either the carton, pallet or container depending on the prevailing circumstances. e.g., if we used the traffic light concept: All items would have ‘green status’ until an anomaly was detected over one item. That detection should turn the status of the entire carton to ‘amber status’. If further anomalies were detected then at a certain level of anomalies and depending on the anomaly pattern the further detection should create warnings for the entire carton, pallet or container that may result in all the items associated with that carton, pallet or container being marked red and being listed as either spent items or item not suitable for sale or supply.

The carton may then be withdrawn from sale by the pharmacy and returned to the manufacturer/Originator for a refund. This capability is an optional feature that is one of the rights the Originator will have the power to impose (or elect not to impose) at the time the Item is originated.

### Conditionality

A further ability the Originator may elect to exercise is the power to attribute a specified condition to an Item or to require certain conditions to be met in relation to a given Item or group of Items.

Such conditions may relate to temperature, location or any one of numerous other conditions the Originator may select (“Condition”).

### Temperature Condition Example

This is an example that shows how the System may be used to show something did not happen. i.e., satisfaction of the Condition (because the Condition was not breached) is determined and recorded against the Item's ID on the Blockchain.

In summary, with reference to FIG. 19, a Device is installed in or on the Item and the Originator.

The Device matches the Item to the relevant Item ID on the Blockchain. Checking the Blockchain for data stored in relation to a given Item ID may be part of the custody transfer process.

The Device in accordance with Originator's settings, reports a state (e.g., which may include the satisfaction or breach of a condition).

The Originator may be a meat packing business that requires its shipments to be transported and delivered with the optimum temperature range for the container (Item) having been maintained during all relevant times in the shipping process.

A sensor/device (“Device”) may be installed in or on the Item and the Originator may match that Item to the relevant Item ID on the Blockchain.

A Device would report a state (which may include the satisfaction or breach of a condition) at a given point in time and add that data to the Blockchain so that data can be later retrieved and determined.

The Device may be read by any person accepting custody of the Item as set out in the previous example. The ability to read the Device would primarily depend on:

the location of the Device (being within, around or on the Item);
the ease of access to the Device; and
the Originator's chosen access, security and anti-tampering protocols.

Alternatively, the Originator may elect to only have the data read at the final distribution point. At that time, the Device may be read to determine if the Condition was satisfied at all times during the shipping process.

Stated another way, the Device may be read (with the outcome of that Check being recorded on the Blockchain) to determine if the shipment was kept within the required temperature range at all times during the shipping process and the shipment was therefore suitable and safe for sale and consumption.

An advantage of an intermediate Check or verification of the status of Device and whether the Condition remained satisfied is that liability may more effectively be determined if a breach of the Condition resulted in loss or damage or any other claim related to the Item.

An intermediate Check on the status of the Device may help identify a range of pertinent data. Some useful data may be to indicate:

where a Condition was breached;
the cause of the breach; and/or
the entity liable (a central registry, as discussed above, may assist in this process though it is not strictly necessary) for the breach.

An entity may be deemed liable for the breach either as a function of:

an act;
a failure to act; or
as a function of their custodial duties.

In the third instance (re custodial duties), some of the data the Device may be enabled to record/display/indicate/report may include:

the time of the breach;
the relevant period between Check A and Check B (when the record of the Device's data stored on the Blockchain indicates the period or shipment stage in which the Condition was breached); or
the shipment stage in which the breach occurred.

### Location Condition Example

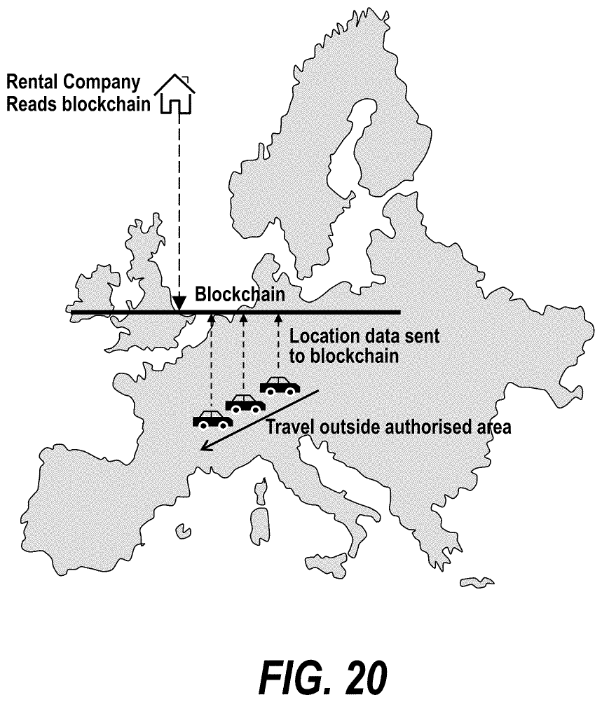

With reference to FIG. 20, there is shown an example that shows how the System may be used to show something did happen. (i.e., a breach of the Condition is determined and recorded against the Item's ID on the Blockchain).

Some of the other conditions we may check for are shock (was the container dropped, light (was the item opened), vibration, humidity, contamination by radiation or foreign chemicals), moisture etc.

In this example the Originator is a car rental company that has restrictions on where their vehicle may be taken during the hire period. For example, due to insurance requirements, the hirer may be prohibited from taking the vehicle into country X. It is clearly stated in the car hire agreement that taking the vehicle into country X would breach the conditions of hire agreed between the car company and the hirer.

A Device may be installed on or in the vehicle (Item) by the rental company (Originator) to retain a record of the Item's location at all times during the relevant hire period. For record verification, that Device may periodically update (e.g., daily) the data record of the Item on the Blockchain.

Alternatively, the Item may be authorized to immediately report any anomalies (that the Device detects) against the Item ID recorded on the Blockchain.

The authority to report/record data on the Blockchain against any given Item ID may be delegated by the Originator to either the Item, the Device or both.

When the vehicle is returned, the Originator may check the Device and/or the data record stored on the Blockchain in relation to the relevant Item ID to determine if the condition was breached.

The Originator may have originally charged a condition compliance premium from the hirer. If the Condition was not breached, the Originator may return that premium amount to the hirer.

### Unauthorized Package Inserted or Substitution

It is possible for the custody protocol being set by the Originator to be “do not accept custody of any Item if the Item's seal has been broken by anyone other than a Monitor.”

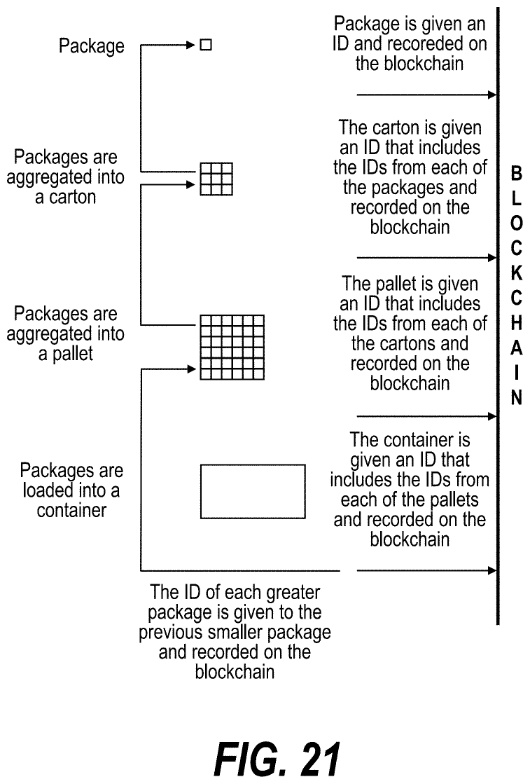

With reference to FIG. 21 and a means of doubling the protection, the following procedures may also be followed.

By recording the larger package ID against the smaller package, it is possible to prevent unauthorized packages being inserted into an already aggregated package.

One use for this might include tainted goods included in what would otherwise be an authorized shipment.

If a package is swapped out it will not have the ID of its parent package.

### Further Examples

### Fashion House Example

A fashion house concerned about supply chain integrity and ethical clothing, may obtain proof that workers were fairly paid and no child labor was involved in the production process. At present that system is difficult to enforce because the records are held by the factory and there is considerable scope for false records to be created or for records to be altered.

If the System was used as part of a blockchain-based supply chain, then the fashion house may audit an unchangeable set of records about hours worked, salaries and factory output. If workers were paid in a digital currency such as Bitcoin and that payment process was integrated into the System, there would be an immutable record of those payments.

In the future, the currency may be even be the digital currency of a sovereign state.

Regardless of whether a nation state issued digital currency or some other digital currency was used, the record of payment may be a verifiable and auditable fact. With the surge of interest in blockchain technology, many companies are working on verification tools that can mine blockchain records. It will be increasingly possible for other important data to be analyzed and confirmed. The System may be integrated into those processes.

Equally, consumers of those items would also be able to interrogate the System (using the unique ID of the garment they purchased) to verify that the clothing, footwear, handbag or another item was ethically produced.

### Industry Regulator Example

There is an increasing recognition of the importance of protecting regional brand reputation and authenticity.

The threat of fake or counterfeit products is clear. Counterfeiters are misappropriating a brand reputation for quality and reliability. Those market traits have considerable value and that worth is the very reason the counterfeiters are attracted to the brand. Often that brand reputation has been earned and built over decades or even centuries of hard work. It can easily be eroded or destroyed if fake or sub-standard product penetrates the supply chain.

The System can be used to provide regulators with insights into the particular supply chain. Through the System the regulator may determine the source and quantities of the raw materials and audit the volumes being distributed.

If we take wine for example: a wine regulatory body may look at the records of the quantity and origin of grapes being delivered into the production chain and then determine the volume of authenticated wine that may be produced by the relevant bottling facility. Transparency and auditability would preserve the integrity of the region's brand reputation.

When combined with our food safety example, the System may be used to issue each bottle with a unique ID that can then be tracked through the entire supply chain to the store shelf. The consumer interested in buying a bottle of wine can scan the code on the bottle using the System's app and confirm that there are no supply chain threats detected and the bottle is indeed genuine wine produced in the region stated on the bottle.

### Artwork Collector Example

Under the Artist Resale Royalty Scheme, the Copyright Agency of Australia has been appointed by the government to collect royalties when artworks are resold and to distribute those royalties to the relevant artist.

A combination of embodiments of the present invention as described herein and digital currency can automate that system providing immediate payment to the artist when an item is sold. That process would be underpinned by fully transparent and auditable accounting records.

As mentioned above, the System may be used to generate a unique ID that is assigned to each artwork. That ID would confirm the provenance of the artwork from the time it was created through its entire ownership history—an important evidentiary trail for matters concerning authenticity, proof of ownership and it would also be a formidable fraud protection measure.

### Recycling Example

A manufacturer may be required by law (or in compliance with their own internal ethical production practices) to track the existence of items they have sold. Some major international furniture stores already have a pilot program running to repair or recycle furniture.

In Australia, a major international furniture store already has processes in place for the recycling of cardboard boxes and paper packing, light bulbs, batteries and mattresses. It seems reasonable to assume that more products will be added to that list over time.

The System may be used to assign an ID to each of these items and that identity may be traced from manufacture, to sale and finally to recycling or disposal.

The record keeping immutability and certainty of blockchain data would be useful in this process. As mentioned in other examples above, the ability to make payments using a digital currency may also be integrated into this use of the System.

### Air Freight Example

A manufacturer may also elect to distribute their products by air freight. The same principles would apply to air freight as would apply for marine cargo. The Originator would use the System and apply the encrypted ID to the Item that would then be placed into a carton that was similarly identified. The cartons would be loaded into an air container that was also given an encrypted identification.

The air freight supply chain processes would be similar to the shipping supply chain. A trucking company would collect the packed container from the Originator's warehouse and deliver the identified cargo to the terminal which would in this example be an airport rather than a sea port.

Then, the air container would be identified similarly to a sea container and then it would be loaded onto an aircraft.

The path from the destination airport would be similar to the processes used for sea shipments from port to store.

### Online Example

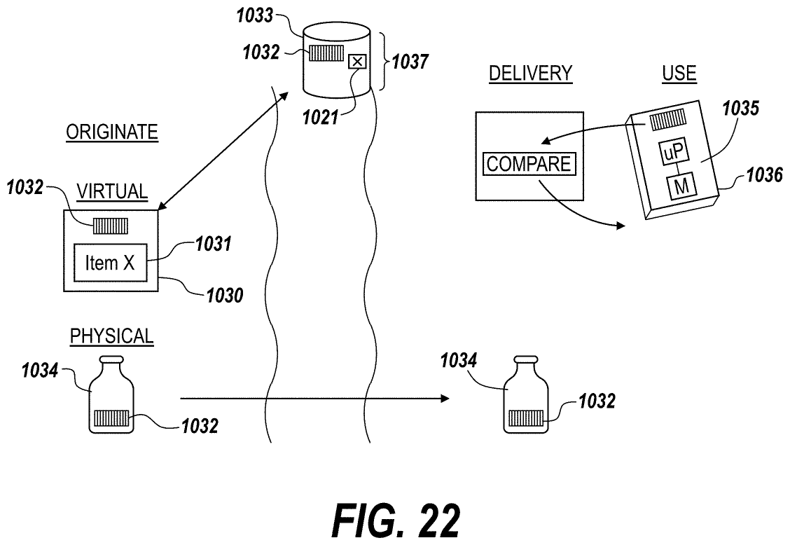

Items sold online may also use the System. FIG. 22 illustrates a further example of the System applied at the granular level to control individual items.

With reference to FIG. 22, a user may purchase an individual item from a specified entity the facilities the sale on a website or mobile site. The individual item has associated with it a code. On receipt of the actual item, the user may use the Application to enter the code associated with that item and receives verification that the code is a genuine code associated with the genuine item and confirmation that the code has not previously been ‘spent’ or extinguished.

Once the system registers that the enquiry has been made and answered, the code is then extinguished from the system or otherwise not made available for reuse.

### High Value or Resale Items

For example, a high value item or an item that is intended for resale by consumers may be tagged with a code to the effect “do not extinguish” with the end result that the identifier will be retained on record indefinitely.

That is, in certain circumstances, the Originator may inform the buyer that the code will not be extinguished. This method would be used where the item was a collectible or other asset type where a historical record of a chain of custody may be important or useful. In these circumstances, different protocols would be applied by the Originator to the code associated with the item. A chain of ownership would commence when the item was shipped and each subsequent custodial change (which may include changes of ownership) would be recorded against the item's code.

With reference to FIG. 22, a purchaser may visit a site 1030 having available thereon item 1031 (represented virtually) for sale (in this instance designated item X). There will be associated with item 1031 a unique code 1032 (in this instance designated code X). The code will not be available to the user by way of the site 1030 but will be stored on server 1033 referenced against item X.

The physical item 1034, being the fulfillment of virtual item 1031, may have associated with it physically code X. On delivery of physical item 1034, a user may use an application 1035 executed on a digital device 1036 to read the code X and to compare code X with the code stored on server 1033. If the codes match, then the user may be confident that the physical item 1034 originated from the originator and is therefore genuine in the sense that it has been supplied directly by or with the sponsorship approval and control of the originator responsible for site 1030.

In preferred forms, a lookup table 1037 is maintained on server 1033 for a wide array of goods or items. In preferred forms, the lookup table is maintained in a blockchain structure maintained by and accessible across a multiplicity of servers 1033.

### Further Embodiments

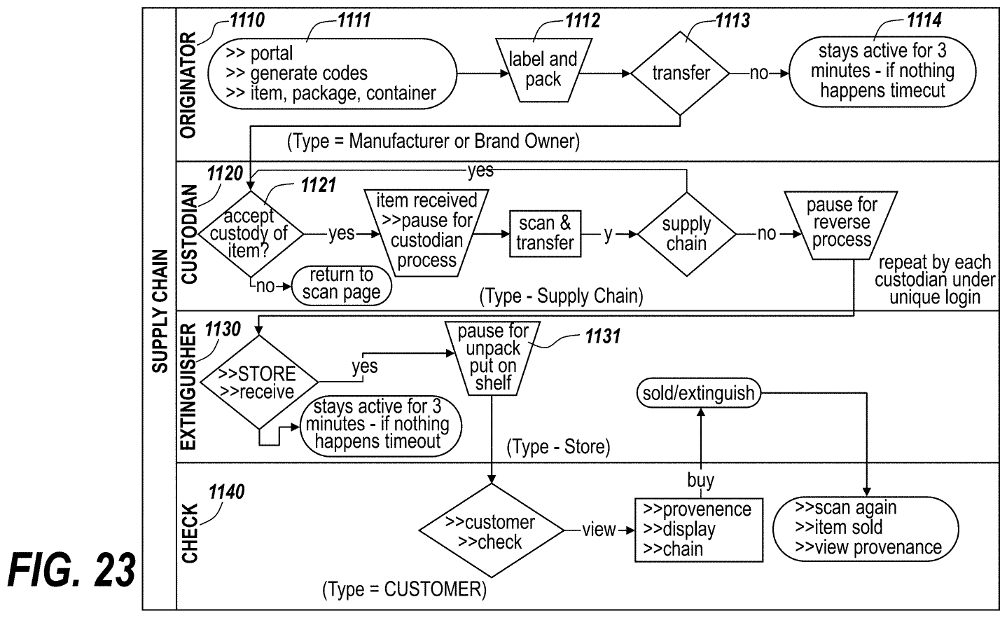

FIG. 23 illustrates a further embodiment of the system applied at the granular level and incorporating a timeout facility.

With reference to FIG. 23 there is illustrated a flowchart of an exemplary implementation of the previously described embodiments.

In this instance an originator 1110 prepares elements and assigns element identifiers in a generation step 1111. The elements are then aggregated and packed in a packing step 1112. The aggregated (and packed) elements are then made available for transfer to a custodian 1120. In this instance the transfer step 1113 is available to be executed only during an active window 1114. The active window 1114 comprises a predetermined time out period. In a preferred form this time out period may be, for example, 3 minutes. If the transfer step 1113 is executed within the active window 1114 then the goods are recorded as transferred to the custodian 1120. The custodian must record acceptance of the item at an acceptance step 1121 resulting in data entry into the custodial chain.

The aggregated elements are then de-aggregated in an unpack step 1131 as part of an extinguisher step 1130 in the supply chain sequence. The de-aggregated items are then checked in a checking step 1140 whereby each de-aggregated item is checked for authenticity.

More specifically with reference to FIGS. 23-25, there is described a time-out process. If the recipient does not accept the item within the sender activating the custodial release of the item, then the release simply lapses. It must then be reactivated by the sender.

The person with custody of the item will continue to hold the item until they transfer custody. If that person scans the code, they are presented with the choice to either transfer the custody of the item or to cancel.

The person wishing to receive custody of the item will upon scanning the code be presented with a message that custody of the item is held by someone else. This all changes once the custodian has activated a transfer of custody. Then a scan will present the person with the option to accept or reject custody of the item. Again, they must take this action within the time-out period (currently set at three minutes).

This facility is used to advantage when implemented as an application on a hand-held device. In a particular form it may be implemented as an application on a smart phone. In a preferred form there may be two versions of the application for use in different contexts. One is a supply version used by originators, custodians and other entities involved in the supply chain.

The customers will use a bare-feature consumer app. It is not capable of transferring custody. However, it does set out the history of the supply chain movements for the particular item being scanned. It also sets out a history of items that have been scanned.

An important feature of the app design for the supply version is that it may simplify the user interaction.

In preferred form a user cannot do anything that is not permitted according to their categorization in the supply chain.

The person with custody of the item will continue to hold the item until they transfer custody. If that person scans the code, they are presented with the choice to either transfer the custody of the item or to cancel.

The person wishing to receive custody of the item will upon scanning the code be presented with a message that custody of the item is held by someone else. This all changes once the custodian has activated a transfer of custody. Then a scan will present the person with the option to accept or reject custody of the item. Again, they must take this action within the time-out period (in preferred forms set at three minutes).

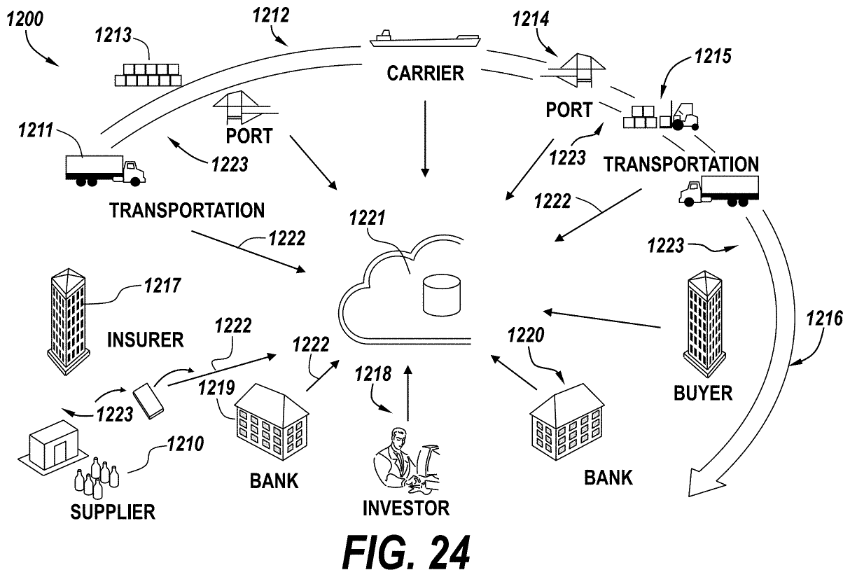

FIG. 24 illustrates a further exemplary embodiment of the system of the present invention.

In this instance the system 1200 is exemplified by a relatively complex supply chain comprising physical processing components including manufacturer/supplier 1210, first transportation 1211 (land-based), second transportation 1212 (sea based), mechanical handling 1213 between the first mode of transport and the second mode of transport, further mechanical handling 1214 between the second mode of transport and a third mode of transport 1215 and a buyer/consumer 1216.

In addition, there are virtual supply chain components including insurer 1217 investor 218, first bank 1219 and second bank 1220.

A database 1221 receives granular data 1222 from all steps along the supply chain including but not limited to at the point of transfer 1223 from one component in the system 1200 to another component in the system 1200.

In preferred forms a hand-held data acquisition device 1224 as described in earlier embodiments is utilized in at least some points in the chain including in at least some points of transfer 1223 to acquire the granular data 1222 for communication to database 1221.

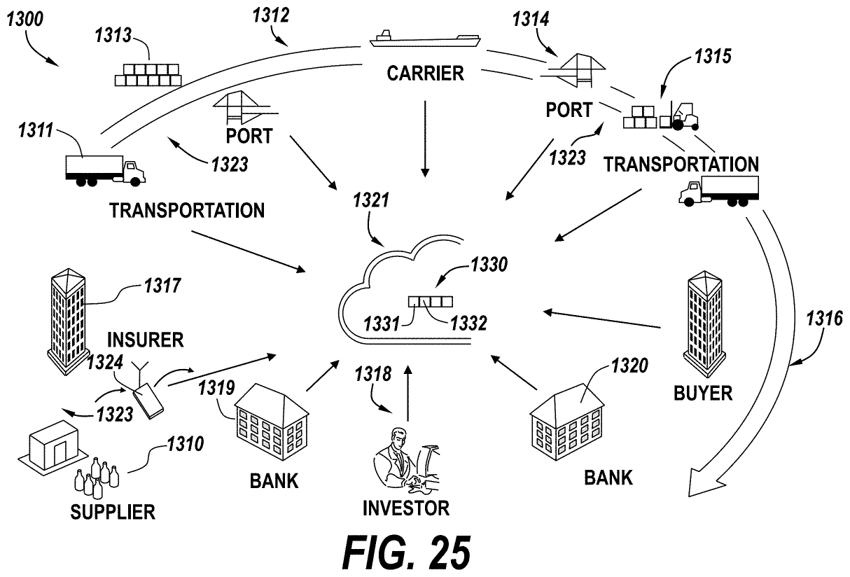

FIG. 25 illustrates yet a further exemplary embodiment of the system of the present invention applied in the context of selective data retention and selective data availability. In this instance like components are numbered as for the embodiment illustrated in FIG. 9 except in the 1300 series. In this instance the database 1321 is supported by a reception of extended granular data 1322 combined with additional data feeds in the data structures of the database 1321 whereby the data records are segmented whereby selected portions of data record 1330 are available to users of the system 1300 on a selective basis. So, for example, a first user may be able to access only record 1331 of the data structure 330 whilst another user may be permitted to access records 1331 and 1332. In some forms the accessibility to a record will be based on an additional parameter to identity-it may include time for example. Alternatively, or in addition it may be based on the location of an item along the chain. That is data in selected fields may be available only whilst an item is, for example, located between a first point of transfer and a second point of transfer.

With particular reference to the arrangement of FIG. 25, and by way of exemplification of it; the system, 1300, makes use of information stored progressively in a database—in preferred forms as a distributed ledger—more preferably of the Blockchain type. The purpose of the system is to verify the contents, security and location of a shipment of items (“System”). It uses information gathered as an item moves along a custodial chain of handlers who pack, store or transport that particular item. It does not matter to the System how many custodians hold and later transfer the item.

The System is concerned with the following information (“Shipment Information”):

1. certainty about the identity of one or more items that may be grouped and packed inside a carton and/or pallet which are then placed into a shipping container either for land, sea, rail or air freight;
2. gathering, storing, disseminating and using information about the container and its contents as a whole;
3. certainty that the content of the container remains intact or that any changes to those items are known; and
4. certainty about the location of the container.

### External Use of the System's Information

The System allows its customers to access the Shipment Information and to make commercial decisions based on that information.

The commercial decisions may relate to decisions related to finance, insurance, legal, or other business issues.

The System provides information about ‘what’ is ‘where’ and ‘when’. The System also confirms that the ‘what’ remains unchanged during the movement of the container along the supply chain.

### Contract Data Construct

A contract data construct is a term given to a data construct that is stored on the database, 1321. Data entered into the data construct, 1330, is shaped by legal processes and concepts to form a method to partly or fully automate contracts (“Smart Contract”). That automation capability may mean that a number of parties are involved in the contract.

Those parties to the Smart Contract may also elect to share some or all the data they individually enter. The data may be entered into the hand-held data acquisition device, 1324, at points along the supply chain, for on communication to the database, 1321. This information sharing may eliminate information duplication as it may eliminate or minimize the repetitive input of similar or identical data by each party into their own data systems.

The concept of Smart Contracts may be reliant on the existence of certain information that triggers the contract's specified action. In the case of a Smart Contract for the supply of goods, the contract's provisions may be triggered and the ownership of the goods may then pass from the seller to the buyer. Intrinsic to that change of ownership may be the change in liability and insurance risks that may happen at the same time.

Any insurers, banks, law firms and accountants that are party to the Smart Contract will have an interest in the effect of the provisions of the contract being triggered in ownership and liability be passed from the seller to the buyer.

Other parties who may participate in a Smart Contract and the related supply chain would be packaging companies, manufacturers, warehouses, logistics companies and brokers, trucking companies, distributors and stores. Depending on the mode of transport, rail yards, railways, shipping lines, sea ports, airlines or airports may also be involved in a particular Smart Contract.

When a Smart Contract's provisions are activated, that trigger is often described as requiring third party information that establishes the relevant facts that cause the trigger to be activated.

Because the System has gathered and stored the data on the supply chain movement of a container, the System can be interrogated by a user which is either a Smart Contract application or the operator of a smart contract application.

### Example

A shipment of wine is to be sold by the seller to a buyer in China. Under the sale terms, payment for the shipment of wine is to be made when the wine is landed in Shanghai.

The shipment is a DES shipment (Delivered Ex Ship). In this type of transaction, it is the seller's responsibility to get the goods to the port of destination or to engage the forwarder to move the cargo to the port of destination uncleared. ‘Delivery’ occurs when the goods arrive in the Shanghai port.

The shipment is one container filled with the Seller's wine. The wine is packed into cartons. Cartons are loaded on pallets. Pallets are loaded into the container and the container is sealed.

The Container is provided with a unique identifying number which may or may not be an encrypted identifier.

The Seller has engaged the services of a freight forwarding company to transport the Container to the Buyer. The freight forward arranges for a trucking company to collect the Container from the Seller's premises.

The trucking company collects the Container and transports it to the port. The port takes custody of the Container which is subsequently loaded onto a ship. The ship transports the Container to Shanghai.

The parties involved in the relevant smart contract are the Seller, the freight forwarding company, the trucking company, the port, the shipping company and the receiving port and the Buyer. The accountants, bankers, insurers and lawyers for all the various parties may also have an interest in the Smart Contract and the progress of the shipment.

The point of delivery may vary from contract to contract depending on the terms agreed between the respective Seller and Buyer. In some instances, the point where ownership and liability move could take place very early in the supply chain.

Regardless of the terms, the information stored in the system on a distributed ledger could be accessed by the Smart Contract to determine if the trigger point for a particular transaction has been reached.

Auditing

An auditor or any other interested third party may use the application to interrogate the database, 1321, to determine the status of a given Item. This data would include any information recorded on the database in relation to the Item's origins, rights limits or the Item's chain of custody.

### Sealing Certainty

In the case that customs or other regulatory authority needs to validly access the Container and the device or technology, the system allows them to take custody of the item, and this is recorded on the database. As a result, a degree of certainty regarding when a container was opened may be obtained.

### Block Chain Structures

Blockchain structures may be used to advantage with any of the above-described embodiments.

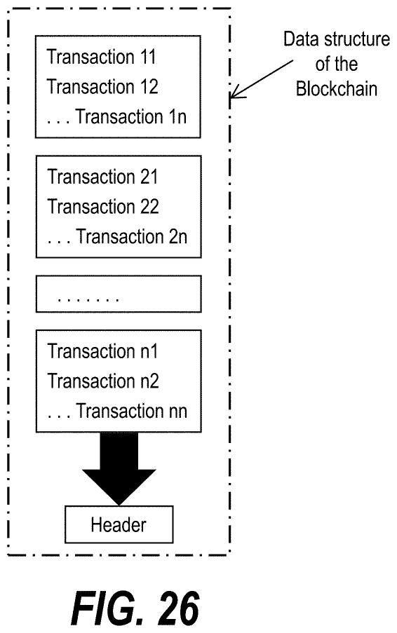

FIG. 26 is a diagram of an exemplary block chain data structure.

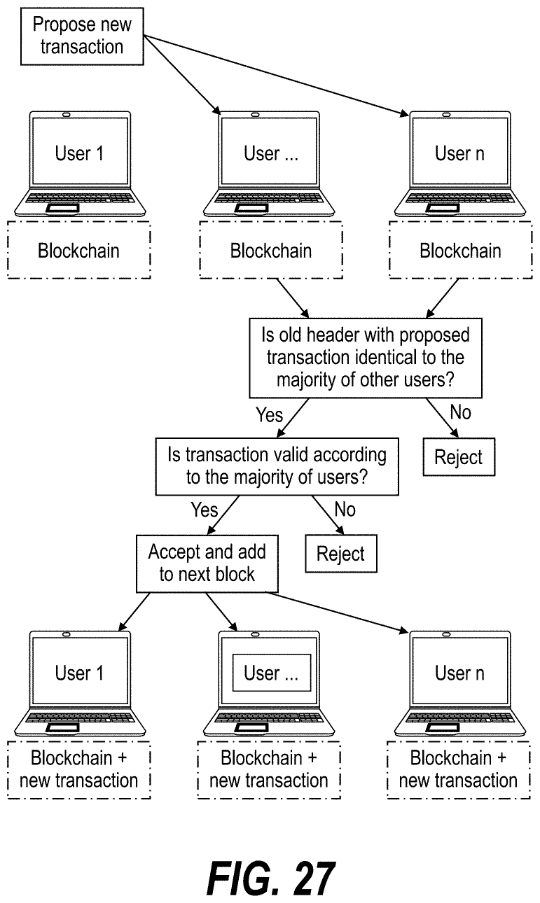

FIG. 27 illustrates diagrammatically use of the block chain data structure of FIG. 26.

With reference to FIGS. 26 and 27, Blockchain is a data structure and distributed record system, which seeks to provide a data structure and system which maintains a complete record of all transactions and minimizes risk of retrospective alterations, or double or identical transactions.

The data structure consists of a series of transactions grouped in blocks, which need to be verified before they are added to the chain. Rules may be set so no data is ever deleted, with the longest chain being taken to be the most recent, and so the chain records all transactions from its initiation in chronological order.

A copy of the chain is kept by all users, and so is a distributed record system. Before any transactions are added the majority of the users need to agree that the transaction is acceptable and then it is bundled with other acceptable transactions into a block, which is added to the chain. Each block has a header which can only be created knowing all the previous transactions. As a result, if a retrospective alteration is made the header will be incorrect and any new block proposed by that user will be rejected. The security of the system is further enhanced by having mathematical problems that can only be solved by trial and error, which use the header and must be solved and then verified by the majority of other users before a block is accepted into the chain by all users. As long as there are more genuine users than coordinated attackers trying to alter the chain then the chain will be secure. There may be other methods used to determine the veracity of a block of data, this may include voting or consent processes where parties with a stake in the transaction or related transactions or in the chain itself are granted ‘voting’ rights. Another process may involve a random or systematized voting or approval system where the validity of the block of data is approved in accordance with a set of protocols agreed by those with a stake in the veracity of the chain of data.

In a more particular form, each block includes verified transactions and the blockchain maintains a ledger all prior transactions. The blockchain is duplicated by all the computers on a network.

The first block in the chain is known as the Genesis block and new blocks can be added in linear and chronological order. From any given block in the chain the information of this genesis block and all blocks that led back to this one can be retrieved. A blockchain is essentially numerous blocks connected through hash chaining where each block is comprised of the following.

Timestamp: provides proof that the data in a block existed at a particular time.

Previous Hash: Essentially a pointer to the previous block.

Merkle Hash: Summary of all executed transactions.

Nonce: Individual blocks identity and is an arbitrary number which can only be used once.

The blockchain is managed by a network of distributed nodes where each node contains a copy of the entire blockchain. Each node in the network can add blocks to the chain, where every node is adding blocks at the same point in the chain at the same time. The more nodes that comprise the network the harder it is to disrupt the storage of the blockchain. Unlike centralized systems which rely on a single authority, there is no single point of failure in these distributed nodes network. If you change the content of a block, you change its Hash.

### Unambiguous Identification and Tracking

Below is a detailed description of an implementation of the methodology described earlier with reference to FIGS. 1A and 1B.

### Digital Twins

One application of the invention could involve use of information regarding an item's unique identity and location to create a digital twin in the form of a non-fungible token (NFT). An NFT could represent a dairy cow for example or a beef steer.

There could be just one NFT for each animal. The cattle manager (“Manager”) would use the platform to create the NFT for an animal. Animals could be collated or grouped into a collection of animals that could then be displayed on an exchange to attract bids from buyer. If the NFT is purchased, the contractual terms will deem that the matching animal will also be simultaneously acquired.

A buyer will therefore have dual roles: NFT Holder and Animal Owner. Each role having its respective rights and obligations.

Taking a dairy cow example: From the time of purchase, the NFT Holder would own the animal and the right to any revenue derived from the animal's milk production or from the animal's eventual sale.

The Manager would be contractually bound to continue to care for the animal and receive payment for that care and for the Manager's milking services.

The platform would provide ID verification, movement tracking, and reporting services as well as blockchain and NFT consultancy services.

The ongoing flow of revenue means that ascertaining the identity, location, and condition of the animal will be of importance.

Linking the NFT industry to the agriculture industry is a transformative concept for both industries. Nothing like that exists at present. Collaboration would give investors the opportunity to purchase very tangible assets. Importantly, farm managers would also have the opportunity to unlock a vast pool of new capital.

### Other Revenue Streams

Under the Dairy Model's, there could be secondary trading in cow NFTs on the public NFT exchanges during the life of the cow.

The NFT creators could earn a royalty each time an NFT is sold. A smart contract could be built to capture any royalty flows.

The platform could provide the following services to the Manager to promote the sale of their animal NFTs.
Animal ID Verification
Access to treatment and management data and reports
Creation of a digital twin
Creation of an NFT
Assistance with the registration of the NFT of a public exchange.
Operation of smart contracts to distribute revenue earned from the animal.

The platform could capture and report on data regarding treatments, pregnancy, offspring, movements, transfers, and end of life. Of course, our data collection could be expanded to include additional health or milk production information.

### Animal Identity Technologies

The identity of an animal can be verified using a range of technologies. The NLIS ear tag is the only mandatory ID. Other ID data could be additional data that adds certainty. The ID-verification mix could be varied according to the Manager's operational practices. Various means of confirming the identity of an animal could be linked to add even greater certainty.

The addition of facial recognition would be possible. An even easier method of identification, at least for Holstein cows, would be recognition of their hide patterns

### Milk Meters

One means of monitoring and assessing revenue earned by a particular cow would be to use a device that monitors milk production. Such data events could be recorded and collated and the accumulated total valued could be reported and be periodically paid.

### Investment Proposition

In summary, an investor who purchases one of this type of NFT would actually acquire the ownership of the cow when they purchase from the Manager the non-fungible token that is the ‘digital twin’ of the cow.

The financial incentive for investors would be that they own a real-world asset that has intrinsic market value. An asset that could earn daily (milk) revenue.

### Digital Engagement

We have already seen the fervent interest in online pets and creatures. The Tamagotchi phenomena is just one example. These NFTs would provide an investment opportunity with an extra layer of interest. Deployed correctly and with the right UX, this could be a source of great interest for NFT holders.

The platform would enable the NFT owner to:
Be able to visually identify their cow;
See photos and videos of their cow;
See its location and any movements to other properties;
Monitor daily milk production;
Monitor daily/monthly revenue flow;
Monitor pregnancy and the birth of any offspring.

Very importantly, the investor would benefit from the liquidity of being able to sell the animal's NFT on a public NFT market at any time.

Summary of the Platform's Role
verify each cow's identity
record the PIC where each animal is located
record any movement of an animal to another property use a mortality register to record any animals that die or are lost record health and welfare data for each animal
enable regular reports to be created
create an NFT for each animal
distribute revenue
Use our smart contract capability to capture NFT sale royalties.

### INDUSTRIAL APPLICATION

Embodiments of the invention, as described by way of example above may be utilized with advantage in supply chain management with particular reference to be able to identify anomalies in the chain such as the introduction of non-authorized goods in the form of counterfeit goods.

1. A method of uniquely identifying an item, the item being a member of a batch of nominally identical items, wherein:
each item is characterised by variability within the batch with respect to at least one inherent characteristic of the item; and
the at least one inherent characteristic of the item arises from creation of the item;
said method comprising:
scanning each item with respect to said at least one inherent characteristic thereby to acquire data on the at least one inherent characteristic sufficient to uniquely distinguish the item from other items of the batch;
creating a digital token which contains data which is a function of said at least one inherent characteristic.

2. The method of claim 1 wherein the or at least one inherent characteristic is a measurable property.

3. The method of claim 2 wherein the measurable property is a genetic code of the item.

4. The method of claim 2 wherein the measurable property is a facial characteristic of the item.

5. The method of claim 2 wherein the measurable property is the hide pattern of the item.

6. The method of claim 1 wherein the inherent characteristic includes data pertaining to physical characteristics of the item.

7. The method of claim 6 wherein the data is time-based data.

8. The method of claim 1 further including a step of sensing attributes of the item subsequent to said step of creating said digital token.

9. The method of claim 8 wherein the attributes are sensed periodically and are transmitted to a database as periodically sensed data.

10. The method of claim 9 wherein the database also includes said digital token and the periodically sensed data is associated with said digital token in said database.

11. The method of claim 1 wherein the or at least one inherent characteristic is a characteristic observable in an image formed by scanning of a portion of the item.

12. The method of claim 11 wherein the image is of a portion of a surface of the item.

13. The method of claim 11 wherein the image is one of a plurality of images of the item taken under different lighting conditions or from different viewpoints.

14. The method of claim 1 wherein the inherent characteristic is one of weight, transparency, or a dimension of the item.

15. The method of claim 1 wherein the inherent characteristic is one of colour, or distribution of colour of the item.

16. The method of claim 1 wherein the inherent characteristic is a marking applied to the item in the course of manufacture.

17. The method of claim 1 wherein at least first and second inherent characteristics of the item are scanned whereby to uniquely distinguish the item from other members of the batch.

18. The method of claim 17 wherein the first and second inherent characteristics are different inherent characteristics of the item.

19. A method for tracking an item, being a member of a batch of nominally identical items, comprising, for each item of the batch, the steps of:
in an initial scan acquiring data on at least one inherent characteristic of the item sufficient to uniquely distinguish the item from other items of the batch;
storing the data and/or information derived therefrom sufficient to distinguish the item from other items of the batch, in digital form, on a database;
monitoring parameters of the item periodically after the initial scan.

20. The method of claim 19 wherein at a second location, performing a second scan comprising scanning an item received at the second location for the or each characteristic used in the initial scan;
seeking a match between data and/or information derived therefrom acquired in the second scan with corresponding data stored in the database.

21. The method of claim 19 wherein the or at least one inherent characteristic is a measurable property.

22. The method of claim 19 wherein the measurable property is a genetic code of the item.

23. The method of claim 19 wherein the measurable property is a facial characteristic of the item.

24. The method of claim 19 wherein the measurable property is the hide pattern of the item.

25. The method of claim 19 wherein the inherent characteristic includes data pertaining to physical characteristics of the item.

26. The method of claim 19 wherein the parameter is location.

27. The method of claim 19 wherein the parameter is milk output.

28. The method of claim 19 wherein the parameter is physiology data.
